(19) United States
(12) Patent Application Publication
(10) Pub. No.: US 2007/0153091 A1
(43) Pub. Date: Jul. 5, 2007

(54) Methods and apparatus for providing privacy in a communication system

(76) Inventors: John Watlington, Acton, MA (US); Thibaut Lamadon, Boston, MA (US); Pascal Chesnais, Sudbury, MA (US); Diane Hirsh, Watertown, MA (US)

Correspondence Address: GAZDZINSKI & ASSOCIATES, Suite 375, 11440 West Bernardo Court, San Diego, CA, 92127, US

(21) Appl. No.: 11/323,399

(22) Filed: Dec. 29, 2005

(51) Int. Cl. H04N 5/228

(52) U.S. Cl. 348/208.14

(57) ABSTRACT

Methods and apparatus for providing privacy during video or other communication across a network. In one embodiment, a system is disclosed wherein digital video camera is coupled to a network via a processing server. The digital video camera generates one or more digital images that are processed by the processing server, including identifying and obstructing any artifacts (e.g., faces, hands, etc.) in the images. The processing also optionally includes the tracking of the artifacts in the images as they move within the image, as well as search for new faces that may enter the field of view. In another embodiment of the invention, video conferencing is performed over a network between two or more users. Images are generated by digital video cameras and processed by video servers. During the videoconference, one or more users may select a video (and audio) muting mode during which any artifacts of interest in the images (or portions thereof) are identified and obscured. Business methods utilizing these capabilities are also disclosed.

### BACKGROUND OF THE INVENTION

1. Field of Invention

The present invention is related to the fields of imaging and video communications. More particularly, the present invention relates to methods and apparatus for providing privacy in a video, data network or communication system.

2. Description of Related Technology

Video communication over various types of networks is well known in the digital communication arts. Video communication over networks typically involves digital video cameras that generate images. As used herein, the term “video” refers to both still images and a moving sequence of images or frames. These images are usually compressed and transmitted over a data network such as the Internet. Many other types of networks may also be used for video communication including the standard (circuit switched) telephone system or a satellite based communication system.

Video Broadcast and Conferencing

Video and image communication services include video/image unicast/multicast/broadcast (hereinafter “broadcast”) and video conferencing. To broadcast video or an image over a network, a video server is typically used for distributing the video information to a plurality of other end users. The end users can then use a web browser or other access application or system to view the video stream via the network.

Numerous commercial solutions exist to address the issue of video or image access/broadcasting (including public scene capturing). One can readily access numerous sites on the Internet, for example, where images of local attractions, weather conditions, traffic activity, etc. are broadcast effectively around the clock. However, these motion/image capturing devices have a low resolution, and are generally far from the scene being viewed (for perspective). These factors generally prevent the person viewing the picture from knowing the identity of people present in the scene.

For video conferencing, two or more video cameras can be linked via the interposed network infrastructure (and videoconferencing software) to establish a video interface in real time. The quality of the video can vary from broadcast television quality to periodically updated still images. Video communication can be conducted on virtually any type of network including telephone, data, cable or satellite networks.

Video communication is a powerful method for interacting and sharing information. Being able to view another person's face, body language and gestures, and surroundings increases the ability to understand and exchange information. Accordingly, myriad prior art video communication technologies relating to broadcast and conferencing exist.

For example, U.S. Pat. No. 5,806,005 to Hull, et al. issued on Sep. 8, 1998 and entitled “Wireless image transfer from a digital still video camera to a networked computer” discloses a portable image transfer system including a digital still camera which captures images in digital form and stores the images in a camera memory, a cellular telephone transmitter, and a central processing unit (CPU). The CPU controls the camera memory to cause it to output data representing an image and the CPU controls the cellular telephone transmitter to cause a cellular telephone to transmit the data received from the camera memory. A receiving station is coupled to the cellular telephone transmitter by a cellular network to receive image data and store the images.

U.S. Pat. No. 5,956,482 to Agraharam, et al. issued on Sep. 21, 1999 and entitled “Multimedia information service access” discloses real time delivery of multimedia information accessed either through the Internet, or otherwise, simultaneously, or sequentially time delayed to one more users, and is enabled by delivering the multimedia information over a switched network via a multipoint control unit. A client establishes a connection with a server, or other remote location where desired multimedia information is resident, identifies the desired multimedia information and provides client information identifying the locations of the users. The client information may include the telephone numbers or other access numbers of each of the multiple users. The multimedia server's call to the user triggers the camera to take a picture of the user. The selected content is restricted to authorized users by comparing the picture to pictures of authorized faces stored in the database.

U.S. Pat. No. 6,108,437 to Lin issued on Aug. 22, 2000 and entitled “Face recognition apparatus, method, system and computer readable medium thereof” discloses a face recognition system comprising an input process or circuit, such as a video camera for generating an image of a person. A face detector process or circuit determines if a face is present in an image. A face position registration process or circuit determines a position of the face in the image if the face detector process or circuit determines that the face is present. A feature extractor process or circuit is provided for extracting at least two facial features from the face. A voting process or circuit compares the extractor facial features with a database of extracted facial features to identify the face.

U.S. Pat. No. 6,922,488 to Mastrianni, et al. issued on Jul. 26, 2005 and entitled “Method and system for providing application launch by identifying a user via a digital camera, utilizing an edge detection algorithm” discloses a method and system for automatically launching an application in a computing device (e.g. Internet appliance, or the like) by authenticating a user via a digital camera in the computing device, comprising: obtaining a digital representation of the user via the digital camera; filtering the digital representation with an digital edge detection algorithm to produce a resulting digital image; comparing the resulting digital image to a pre-stored digital image of the user; retrieving user information including an application to be launched in response to a successful comparison result, the user information being associated with the pre-stored digital image of the user; and launching the application.

United States Patent Publication No. 20020113862 to Center, et al. published on Aug. 22, 2002 and entitled “Videoconferencing method with tracking of face and dynamic bandwidth allocation” discloses a video conferencing method that automatically detects, within an image generated by a camera, locations and relative sizes of faces. Based upon the detection, a control system tracks each face and keeps a camera pointed at and focused on each face, regardless of movement about a room or other space. Preferably, multiple cameras are used, and an automatic algorithm selects a best face image and resizes the face image to substantially fill a transmitted frame. Preferably, an image encoding algorithm adjusts encoding parameters to match a currently amount of bandwidth available from a transmission network. Brightness, contrast, and color balance are automatically adjusted. As a result of these automatic adjustments, participants in a video conference have freedom to move around, yet remain visible and audible to other participants.

United States Patent Publication No. 20010016820 to Tanaka, et al. published Aug. 23, 2001 entitled “Image information acquisition transmitting apparatus and image information inputting and recording apparatus”, incorporated herein by reference in its entirety, discloses a face image information acquiring transmitting apparatus, that comprises: a face image information acquiring section to acquire face image information of a customer; a transmitting section to transmit the face image information acquired by the face image information acquiring section to a transmission destination; and a payment receiving section to receive a payment charged to the customer.

United States Patent Publication No. 20020191082 to Fujino, et al. published on Dec. 19, 2002 and entitled “Camera system” discloses a camera system suitable for remote monitoring. The present invention is made by making improvements to a camera system that transmits camera image data to a network. The camera system comprises: a camera head including an image sensor and a sensor controller that controls the image sensor; a video signal processing means that performs video signal processing on image data from the image sensor; and a web server which transmits image data from the video signal processing means as the camera image data to the network, receives control data from the network, and controls at least the sensor controller or the video signal processing means.

United States Patent Publication No. 20040080624 to Yuen, published on Apr. 29, 2004 and entitled “Universal dynamic video on demand surveillance system” discloses a mass video surveillance system. It allows users to have global access to the installed sites and with multiple users at the same time. Users can use generic personal video camcorder or camera instead of expensive industrial surveillance camera. Users can have full control of the camera pan and tilt positions and all the features of the video camera from any part in the world as long as Internet access is available. Furthermore, the users can retrieve the video and audio data and watch it on the monitor screen instantly. This new invention is also a dynamic video on demand video-telephone conferencing system. It allows the users to search, zoom and focus around all the meeting rooms at wish.

United States Patent Publication No. 20040117638 to Monroe, published on Jun. 17, 2004 and entitled “Method for incorporating facial recognition technology in a multimedia surveillance system” discloses facial recognition technology integrated into a multimedia surveillance system for enhancing the collection, distribution and management of recognition data by utilizing the system's cameras, databases, monitor stations, and notification systems. At least one camera, ideally an IP camera is provided. This IP camera performs additional processing steps to the captured video, specifically the captured video is digitized and compressed into a convenient compressed file format, and then sent to a network protocol stack for subsequent conveyance over a local or wide area network. The compressed digital video is transported via Local Area Network (LAN) or Wide Area Network (WAN) to a processor which performs the steps of Facial Separation, Facial Signature Generation, and Facial Database Lookup.

United States Patent Publication No. 20040135885 to Hage published Jul. 15, 2004 and entitled “Non-intrusive sensor and method” discloses a sensor assembly adapted for remotely monitoring spaces such as residences or businesses, with enhanced privacy. In one exemplary embodiment, the sensor assembly is configured to look like a convention passive infrared device (PIR), and includes a CMOS camera and associated data processing. The data processing selectively alters the image data obtained by the camera so as to allow a remote operator to view only certain features of the data, thereby maintaining privacy while still allowing for visual monitoring (such as during alarm conditions to verify “false alarm” status). Alternate system configurations with local and/or remote data processing and hardwired or wireless interfaces are also disclosed.

United States Patent Publication No. 20040202382 to Pilu published Oct. 14, 2004 entitled “Image capture method, device and system”, incorporated herein by reference in its entirety, discloses apparatus and methods wherein a captured image of a scene is modified by detecting an inhibit signal emanating from an inhibitor device carried by an object within the scene. In response to receipt of the inhibit signal, identifying a portion of the image corresponding to the object. The image object of the scene is modified by obscuring the image portion of the object.

Object Detection and Tracking

Object detection and tracking are useful in video and image processing. Inherent in object detection tracking is the need to accurately detect and locate the target object or artifact as a function of time. A typical tracking system might, e.g., gather a number of sequential image frames via a sensor. It is important to be able to accurately resolve these frames into regions corresponding to the target being tracked, and other regions not corresponding to the target (e.g., background).

One very common prior art approach to image location relies on direct spatial averaging of such image data, processing one frame of data at a time, in order to extract the target location or other relevant information. Such spatial averaging, however, fails to remove image contamination. As result, the extracted object locations have a lower degree of accuracy than is desired.

Two fundamental concepts are utilized under such approaches: (i) the centroid method, which uses an intensity-weighted average of the image frame to find the target location; and (ii) the correlation method, which registers the image frame against a reference frame to find the object location.

Predominantly, the “edge N-point” method is used, which is a species of the centroid method. In this method, a centroid approach is applied to the front-most N pixels of the image to find the object location.

However, despite their common use, none of the foregoing methods (including the N-point method) is well suited to use in applications for face or other body part detection.

A number of other approaches to image acquisition/processing and object tracking are disclosed in the prior art as well. For example, U.S. Pat. No. 4,671,650 to Hirzel, et al. issued Jun. 9, 1987 entitled “Apparatus and method for determining aircraft position and velocity” discloses an apparatus and method for determining aircraft position and velocity. The system includes two CCD sensors which take overlapping front and back radiant energy images of front and back overlapping areas of the earth's surface. A signal processing unit digitizes and deblurs the data that comprise each image. The overlapping first and second front images are then processed to determine the longitudinal and lateral relative image position shifts that produce the maximum degree of correlation between them. The signal processing unit then compares the first and second back overlapping images to find the longitudinal and lateral relative image position shifts necessary to maximize the degree of correlation between those two images. Various correlation techniques, including classical correlation, differencing correlation, zero-mean correction, normalization, windowing, and parallel processing are disclosed for determining the relative image position shift signals between the two overlapping images.

U.S. Pat. No. 4,739,401 to Sacks, et al. issued Apr. 19, 1988 and entitled “Target acquisition system and method” discloses a system for identifying and tracking targets in an image scene having a cluttered background. An imaging sensor and processing subsystem provides a video image of the image scene. A size identification subsystem is intended to remove background clutter from the image by filtering the image to pass objects whose sizes are within a predetermined size range. A feature analysis subsystem analyzes the features of those objects which pass through the size identification subsystem and determines if a target is present in the image scene. A gated tracking subsystem and scene correlation and tracking subsystem track the target objects and image scene, respectively, until a target is identified.

U.S. Pat. No. 5,150,426 to Banh, et al. issued Sep. 22, 1992 entitled “Moving target detection method using two-frame subtraction and a two quadrant multiplier” discloses a method and apparatus for detecting an object of interest against a cluttered background scene. The sensor tracking the scene is movable on a platform such that each frame of the video representation of the scene is aligned, i.e., appears at the same place in sensor coordinates. A current video frame of the scene is stored in a first frame storage device and a previous video frame of the scene is stored in a second frame storage device. The frames are then subtracted by means of an invertor and a frame adder to remove most of the background clutter. The subtracted image is put through a first leakage reducing filter, preferably a minimum difference processor filter. The current video frame in the first frame storage device is put through a second leakage-reducing filter, preferably minimum difference processor filter. The outputs of the two processors are applied to a two quadrant multiplier to minimize the remaining background clutter leakage and to isolate the moving object of interest.

U.S. Pat. No. 5,640,468 to Hsu issued Jun. 17, 1997 entitled “Method for identifying objects and features in an image” discloses scene segmentation and object/feature extraction in the context of self-determining and self-calibration modes. The technique uses only a single image, instead of multiple images as the input to generate segmented images. First, an image is retrieved. The image is then transformed into at least two distinct bands. Each transformed image is then projected into a color domain or a multi-level resolution setting. A segmented image is then created from all of the transformed images. The segmented image is analyzed to identify objects. Object identification is achieved by matching a segmented region against an image library. A featureless library contains full shape, partial shape and real-world images in a dual library system.

U.S. Pat. No. 5,647,015 to Choate, et al. issued Jul. 8, 1997 entitled “Method of inferring sensor attitude through multi-feature tracking” discloses a method for inferring sensor attitude information in a tracking sensor system. The method begins with storing at a first time a reference image in a memory associated with tracking sensor. Next, the method includes sensing at a second time a second image. The sensed image comprises a plurality of sensed feature locations. The method further includes determining the position of the tracking sensor at the second time relative to its position at the first time and then forming a correlation between the sensed feature locations and the predetermined feature locations as a function of the relative position. The method results in an estimation of a tracking sensor pose that is calculated as a function of the correlation.

U.S. Pat. No. 5,699,449 to Javidi issued on Dec. 16, 1997 and entitled “Method and apparatus for implementation of neural networks for face recognition” discloses a method and apparatus for implementation of neural networks for face recognition. A nonlinear filter or a nonlinear joint transform correlator (JTC) employs a supervised perceptron learning algorithm in a two-layer neural network for real-time face recognition. The nonlinear filter is generally implemented electronically, while the nonlinear joint transform correlator is generally implemented optically. The system implements perception learning to train with a sequence of facial images and then classifies a distorted input image in real-time. Computer simulations and optical experimental results show that the system can identify the input with the probability of error less than 3%. By using time multiplexing of the input image under investigation, that is, using more than one input image, the probability of error for classification can ostensibly be reduced to zero.

U.S. Pat. No. 5,850,470 to Kung, et al. issued Dec. 15, 1998 entitled “Neural network for locating and recognizing a deformable object” discloses a system for detecting and recognizing the identity of a deformable object such as a human face, within an arbitrary image scene. The system comprises an object detector implemented as a probabilistic DBNN, for determining whether the object is within the arbitrary image scene and a feature localizer also implemented as a probabilistic DBNN, for determining the position of an identifying feature on the object. A feature extractor is coupled to the feature localizer and receives coordinates sent from the feature localizer which are indicative of the position of the identifying feature and also extracts from the coordinates information relating to other features of the object, which are used to create a low resolution image of the object. A probabilistic DBNN based object recognizer for determining the identity of the object receives the low resolution image of the object inputted from the feature extractor to identify the object.

U.S. Pat. No. 6,226,409 to Cham, et al. issued May 1, 2001 entitled “Multiple mode probability density estimation with application to sequential markovian decision processes” discloses a probability density function for fitting a model to a complex set of data that has multiple modes, each mode representing a reasonably probable state of the model when compared with the data. Particularly, an image may require a complex sequence of analyses in order for a pattern embedded in the image to be ascertained. Computation of the probability density function of the model state involves two main stages: (1) state prediction, in which the prior probability distribution is generated from information known prior to the availability of the data, and (2) state update, in which the posterior probability distribution is formed by updating the prior distribution with information obtained from observing the data. The invention analyzes a multimodal likelihood function by numerically searching the likelihood function for peaks. The numerical search proceeds by randomly sampling from the prior distribution to select a number of seed points in state-space, and then numerically finding the maxima of the likelihood function starting from each seed point. Furthermore, kernel functions are fitted to these peaks to represent the likelihood function as an analytic function. The resulting posterior distribution is also multimodal and represented using a set of kernel functions. It is computed by combining the prior distribution and the likelihood function using Bayes Rule.

U.S. Pat. No. 6,553,131 to Neubauer, et al. issued Apr. 22, 2003 entitled “License plate recognition with an intelligent camera” discloses a camera system and method for recognizing license plates. The system includes a camera adapted to independently capture a license plate image and recognize the license plate image. The camera includes a processor for managing image data and executing a license plate recognition program device. The license plate recognition program device includes a program for detecting orientation, position, illumination conditions and blurring of the image and accounting for the orientations, position, illumination conditions and blurring of the image to obtain a baseline image of the license plate. A segmenting program for segmenting characters depicted in the baseline image by employing a projection along a horizontal axis of the baseline image to identify positions of the characters. A statistical classifier is adapted for classifying the characters. The classifier recognizes the characters and returns a confidence score based on the probability of properly identifying each character.

United States Patent Publication No. 20040022438 to Hibbard published Feb. 5, 2004 entitled “Method and apparatus for image segmentation using Jensen-Shannon divergence and Jensen-Renyi divergence” discloses a method of approximating the boundary of an object in an image, the image being represented by a data set, the data set comprising a plurality of data elements, each data element having a data value corresponding to a feature of the image. The method comprises determining which one of a plurality of contours most closely matches the object boundary at least partially according to a divergence value for each contour, the divergence value being selected from the group consisting of Jensen-Shannon divergence and Jensen-Renyi divergence.

Deficiencies of the Prior Art

Despite the foregoing broad range of prior art video and image broadcast and conferencing solutions, none adequately address the issue of video or image “muting”; i.e., the ability to selectively and dynamically obscure artifacts or objects within a real-time or near-real time image or stream, such as to maintain personal privacy of identity or communication. For example, it may be desirable to talk “off line” (both in terms of video images and audio) during a videoconference while still maintaining the video link. In other cases, a user may wish to remain anonymous during the communication. There is also a need for masking of hand and body gestures (even to extend to sign language), whereby such gestures might otherwise communicate information not desired to be communicated to other parties in the videoconference.

Similarly, in real-time image broadcast situations, there is a salient need for apparatus and methods that will dynamically maintain the privacy and anonymity of persons present within the broadcast images, yet still allow remote users the ability to obtain a representative sampling of the ambiance of the monitored location in real time (so-called “visual immediacy”). Such capability would be especially useful in an on-line business context; e.g., when used with on-line business or service directories.

Furthermore, many prior art object detection and tracking techniques that might be used in the foregoing applications are very computationally intensive, thereby making their use on “thinner” mobile devices more difficult and less efficient. What is needed is a suitably accurate by cycle-efficient technique for image processing and object tracking that can be used on any number of different hardware and software platforms, to include even small handheld mobile devices.

### SUMMARY OF THE INVENTION

The foregoing needs are satisfied by the present invention, which discloses methods and apparatus for providing privacy and image control in a video communication or broadcast environment.

In a first aspect of the invention, a method for generating a video transmission of a subject is disclosed. In one embodiment, the method comprises: generating a first digital image of the subject; processing the first digital image to locate at least one artifact in the digital image; obscuring at least a portion of the at least one artifact in the first digital image, thereby producing an obscured digital image; and transmitting the obscured image over a network. In one variant, the method further comprises receiving a second digital image of the subject; tracking the at least one artifact in the second digital image based at least in part on the location of the at least one artifact in the first digital image; and obscuring at least a portion of the at least one artifact in the second digital image. The relevant portions of the image may be obscured using any number of techniques such as reducing the resolution of the image in a region occupied at least in part by the at least one artifact, or overlaying that region with another image. A Viola and Jones or Haar face detector algorithm is used in this embodiment as well, with tracking performed according to the method comprising: performing template tracking of the at least one artifact; and performing Bayesian tracking of the at least one artifact.

In a second aspect of the invention, apparatus for performing video conferencing over a network is disclosed. In one embodiment, the apparatus comprises: a video server in data communication with video camera apparatus adapted to create a stream of video images represented as digital data. The server is adapted to receive the digital data, the server further being configured to process the data to: locate one or more artifacts in the images; and obscure the artifacts in a mute mode of operation. The video server is further adapted to transmit the stream of video images, including the images having the artifacts obscured, over a data network to at least one distant user as part of a video conferencing session such as an H.323 or SIP session. The video server can further be configured to track the artifacts between individual ones of the video images, using e.g., the aforementioned template tracking and Bayesian tracking of the face(s). The video server can also be configured to detect motion between the first image and the second image; and obscuring an area in at least the second image where motion is detected.

In a third aspect of the invention, apparatus for remotely displaying a sequence of video images from a public place is disclosed. In one embodiment, the video images generated by at least one a video camera disposed the public place, and the apparatus comprises: a processing server comprising an interface adapted to receiving the sequence of video images from the at least one camera; a processor; and a computer program running on the processor, the computer program comprising at least one module adapted to locate at least one face within at least individual ones of the video images, the at least one module further being adapted to selectively obscure at least portions of the at least one faces.

In a fourth aspect of the invention, a method of recursive image tracking is disclosed. In one embodiment, the method comprises: providing a tracking algorithm having first and second tracking routines; performing the first tracking routine at least once with respect to at least one image frame; evaluating whether at least one first criterion has been met; if the at least one first criterion has been met, then performing the second routine at least once; after completion of the at least one performance of the second routine, evaluating at least one second criterion; and if the at least one second criterion has been met, terminating the method for at least a period of time.

In one variant, the first routine comprises a template tracking routine, while the second routine comprises a Bayesian routine. The routines are “nested” so that the template tracker runs more frequently than the Bayesian loop, thereby optimizing the operation of the methodology as a whole.

In a fifth aspect of the invention, a method of updating image state in a sequence of video images is disclosed.

In a sixth aspect of the invention, a method of doing business by providing selective video (and optionally audio) masking or privacy as part of user location viewing over a network is disclosed.

In a seventh aspect of the invention, a method of doing business by providing selective video (and optionally audio) masking or privacy over a network in a video conferencing environment is disclosed.

In an eighth aspect of the invention, an integrated circuit (IC) device embodying the image processing and/or tracking methodologies and algorithms of the invention is disclosed.

These and other features of the invention will become apparent from the following description of the invention, taken in conjunction with the accompanying drawings.

### BRIEF DESCRIPTION OF THE DRAWINGS

FIG. 1 is a functional block diagram of an exemplary video broadcast system and network configuration useful with the present invention.

FIG. 1a is a graphical representation of an exemplary database update process according to the invention.

FIG. 1b illustrates an exemplary format for a database record or entry for a monitored location.

FIG. 1c comprises an exemplary message format useful with the information and image servers of the system of FIG. 1.

FIG. 1d is a logical flow diagram illustrating one embodiment of the image, processing, and information server processing performed by the system of FIG. 1.

FIG. 1e is a block diagram of an exemplary image processing module or “block”, including inputs and outputs.

FIG. 1f is a graphical representation of one embodiment of the “chain” processing algorithm of the invention.

FIG. 2 is a logical flow chart illustrating one exemplary embodiment of the method of processing images from one or more locations according to the invention.

FIG. 3 is a functional block diagram of an exemplary video conferencing system and network configuration useful with the present invention.

FIG. 3a is a graphical representation of three alternate configurations for the image processing of the invention with respect to other network components.

FIG. 4 is a logical flow chart illustrating one exemplary embodiment of the method of processing images during a video or multimedia conference according to the invention.

FIG. 5 is a logical flow chart illustrating one exemplary embodiment of the method of tracking artifacts across two or more images (frames) according to the invention.

FIG. 5a is a graphical representation of one exemplary implementation of the tracking methodology according to the present invention, including relative “cycle counts”.

### DETAILED DESCRIPTION OF THE INVENTION

Reference is now made to the drawings wherein like numerals refer to like parts throughout.

As used herein, the terms “network” and “bearer network” refer generally to any type of telecommunications or data network including, without limitation, wireless and Radio Area (RAN) networks, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the terms “radio area network” or “RAN” refer generally to any wireless network including, without limitation, those complying with the 3GPP, 3GPP2, GSM, IS-95, IS-54/136, IEEE Std. 802.11, Bluetooth, WiMAX, IrdA, or PAN (e.g., IEEE Std. 802.15) standards. Such radio networks may utilize literally any air interface, including without limitation DSSS/CDMA, TDMA, FHSS, OFDM, FDMA, or any combinations or variations thereof.

As used herein, the terms “Internet” and “internet” are used interchangeably to refer to inter-networks including, without limitation, the Internet.

As used herein, the terms “client device” and “end user device” include, but are not limited to, personal computers (PCs) and minicomputers, whether desktop, laptop, or otherwise, and mobile devices such as handheld computers, PDAs, and smartphones or joint or multifunction devices (such as the Motorola ROKR music and telephony device).

As used herein, the terms “client mobile device” and “CMD” include, but are not limited to, personal digital assistants (PDAs) such as the “Palm®” family of devices, handheld computers, personal communicators such as the Motorola Accompli or MPx 220 devices, J2ME equipped devices, cellular telephones such as the Motorola A845, “SIP” phones such as the Motorola Ojo, personal computers (PCs) and minicomputers, whether desktop, laptop, or otherwise, or literally any other device capable of receiving video, audio or data over a network.

As used herein, the term “network agent” refers to any network entity (whether software, firmware, and/or hardware based) adapted to perform one or more specific purposes. For example, a network agent may comprise a computer program running in server belonging to a network operator, which is in communication with one or more processes on a client device or other device.

As used herein, the term “application” refers generally to a unit of executable software that implements a certain functionality or theme. The themes of applications vary broadly across any number of disciplines and functions (such as communications, instant messaging, content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the Java™ environment.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “server” refers to any computerized component, system or entity regardless of form which is adapted to provide data, files, applications, content, or other services to one or more other devices or entities on a computer network.

Additionally, the terms “selection” and “input” refer generally to user or other input using a keypad or other input device as is well known in the art.

As used herein, the term “speech recognition” refers to any methodology or technique by which human or other speech can be interpreted and converted to an electronic or data format or signals related thereto. It will be recognized that any number of different forms of spectral analysis such as, without limitation, MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the invention disclosed herein.

As used herein, the term “CELP” is meant to include any and all variants of the CELP family such as, but not limited to, ACELP, VCELP, and QCELP. It is also noted that non-CELP compression algorithms and techniques, whether based on companding or otherwise, may be used. For example, and without limitation, PCM (pulse code modulation) or ADPCM (adaptive delta PCM) may be employed, as may other forms of linear predictive coding (LPC).

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “integrated circuit (IC)” refers to any type of device having any level of integration (including without limitation ULSI, VLSI, and LSI) and irrespective of process or base materials (including, without limitation Si, SiGe, CMOS and GAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the term “display” means any type of device adapted to display information, including without limitation CRTs, LCDs, TFTs, plasma displays, LEDs, and fluorescent devices.

As used herein, the term “database” refers generally to one or more tangible or virtual data storage locations, which may or may not be physically co-located with each other or other system components.

As used herein, the terms “video” and “image” refer to both still images and video or other types of graphical representations of visual imagery. For example, a video or image might comprise a JPEG file, MPEG or AVC-encoded video, or rendering in yet another format.

Overview

In one exemplary aspect, the present invention comprises methods and associated apparatus for providing privacy during video or image communication across a network. This privacy is used in two primary applications: (i) video or image broadcast over a network such as the Internet (to include unicast and multicast), and (ii) video teleconferencing between multiple parties at disparate locations.

In one aspect of the invention, a “broadcast” system is disclosed wherein digital video camera is coupled to a network via a processing server. The digital video camera generates one or more digital images that are processed by the processing server, including detecting and obstructing any artifacts (e.g., faces, hands, etc.) within the images in order to, inter alia, maintain the identity of the persons associated with the artifacts private. The processing also includes tracking of the artifacts of the images as they move within the image (so as to permit dynamic adjustment for movement, changes in ambient lighting, etc.), as well as dealing with new faces that may enter the field of view (or existing faces that leave the field of view).

In alternate embodiments, the camera itself is equipped to conduct much or all of the processing associated with the captured image(s), thereby simplifying the architecture further.

In another aspect of the invention, video conferencing is performed over a network between two or more remote users. Images are generated by digital video cameras and processed by video servers. During the videoconference, one or more users may select a video (and optionally audio) muting mode, during which any artifacts of interest in the images (or portions thereof) are identified and obscured. For example, a conference participant may desire to mute the image of their face (and mouth), as well as their hands, so as to avoid communicating certain information to the other parties on the videoconference.

To provide these functionalities, the present invention also discloses advanced yet highly efficient artifact tracking algorithms which, in the exemplary embodiment, essentially marry so-called “template” tracking techniques with recursive Bayesian techniques. This provides for a high level of accuracy while still maintaining the algorithm relatively compact and efficient from a computational perspective (thereby allowing processing even on “thin” mobile devices).

Other algorithms for handing “open” situations (i.e., where new artifacts may be introduced, or existing artifacts leave the field of view) are also disclosed.

A variety of business methods and paradigms that leverage the foregoing technology are also described.

Advantageously, the conferencing aspects of the present invention can be implemented at one or more nodes of a video or multimedia conferencing system without requiring that all nodes involved in a conference support the solution, thereby providing great flexibility in deployment (i.e., and “end to end” system is not required, but rather each node can be modified to that user's specification ad hoc).

Similarly, the image broadcast aspects of the invention can be implemented with very little additional infrastructure, thereby allowing easy and widespread adoption by a variety of different businesses or other entities.

Furthermore, the invention can be implemented either at the peripheral (e.g., user's desktop PC or mobile device) or in the network infrastructure itself, and can be readily layered on existing systems.

### Detailed Description of Exemplary Embodiments

Exemplary embodiments of the apparatus and methods of the present invention are now described in detail. While various functions are ascribed herein to various systems and components located throughout a network, it should be understood that the configuration shown is only one embodiment of the invention, and performing the same or similar functions at other nodes or location in the network may be utilized consistent with other embodiments of the invention.

Also, the various systems than make up the invention are typically implemented using software running on semiconductor microprocessors or other computer systems the use of which is well known in the art. Similarly, the various process described here are also preferably performed by software running on a microprocessor, although other implementations including firmware, hardware, and even human performed steps, are also consistent with the invention.

It will further be appreciated that while described generally in the context of a network providing service to a customer or consumer end user domain, the present invention may be readily adapted to other types of environments including, e.g., enterprise (e.g., corporate), public service (non-profit), and government/military applications. Myriad other applications are possible.

Lastly, while described primarily in the context of the well-known Internet Protocol (described in, inter alia, RFC 791 and 2460), it will be appreciated that the present invention may utilize other types of protocols (and in fact bearer networks to include other internets and intranets) to implement the described functionality.

The Nature of Artifact Detection—

In its various embodiments, the present invention seeks to, inter alia, detect and track artifacts such as faces, hands, and/or human bodies in such a way that allows their ready and dynamic exploitation; i.e., masking or blanking within still images or video.

Faces are generally not difficult to detect or track because they are highly structured and usually exposed (and hence, skin-colored).

Furthermore, in the context of teleconferencing applications, people taking part in the teleconference are likely to be talking to the camera, or at least seated relative to a fixed location, and so it is reasonable to assume that one will be able to obtain a (more or less) clear frontal view of their face.

Human hands are typically harder to detect than faces because they have many degrees of freedom, and hence can take on many different appearances. Additionally, hands have great freedom to move around and rotate in all directions, sometimes very rapidly. However, hands are usually uncovered (skin colored). Hands also only communicate information (roughly) when they are moving or positioned in certain configurations.

Body parts (torso, arms, legs, etc.) are often hard to detect and track because they have a non-descript shape (roughly rectangular/cylindrical) that may vary significantly, and they also have a wide range of appearances due to different amounts and styles of clothing. However, the body's position is closely related to the position of the head, and hence the latter can be used as an input for detecting various body features.

Location Monitoring and Image Broadcast—

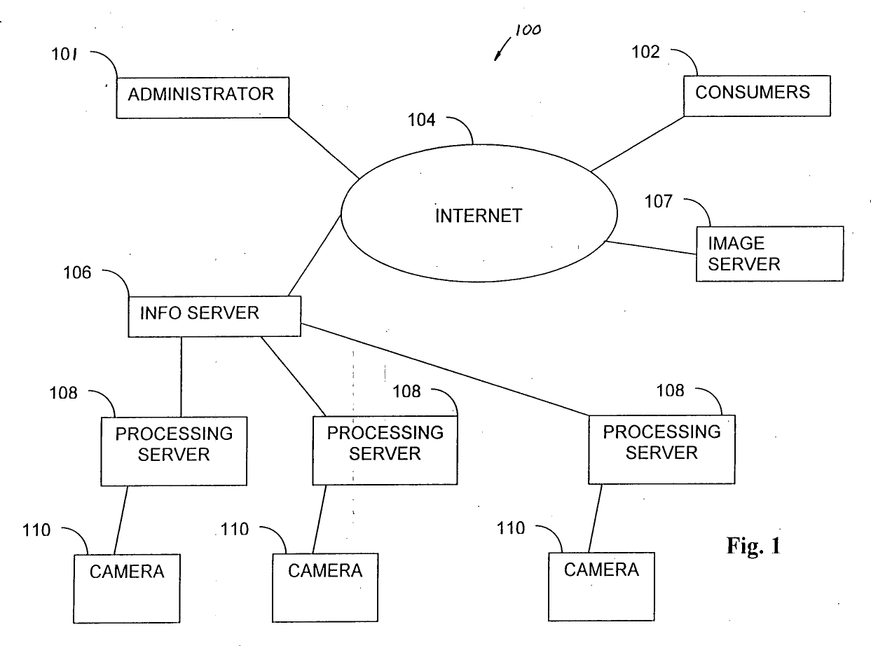

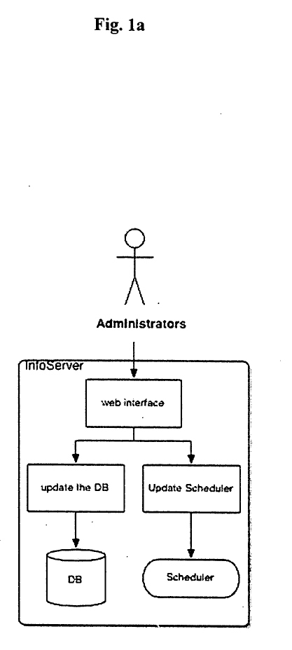

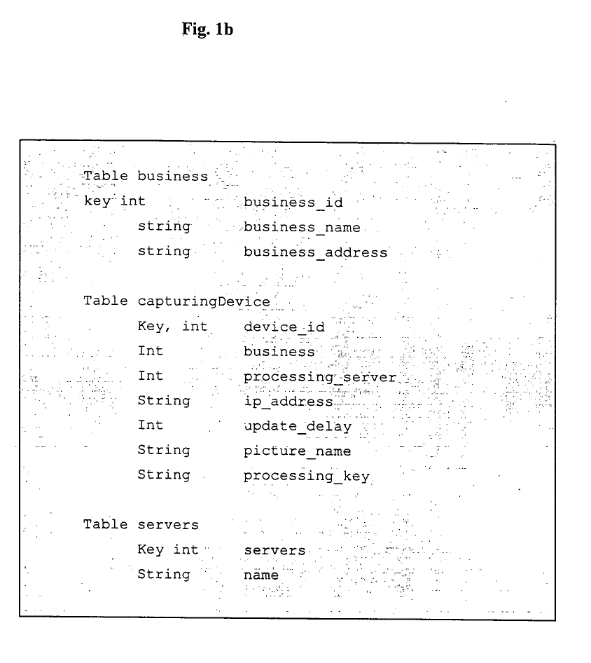

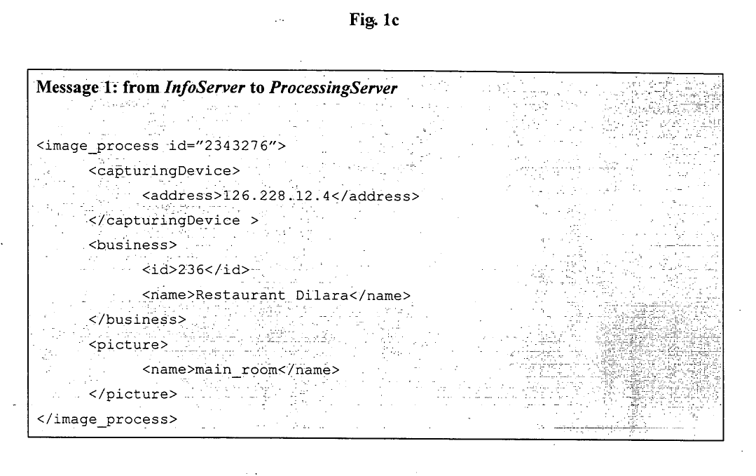

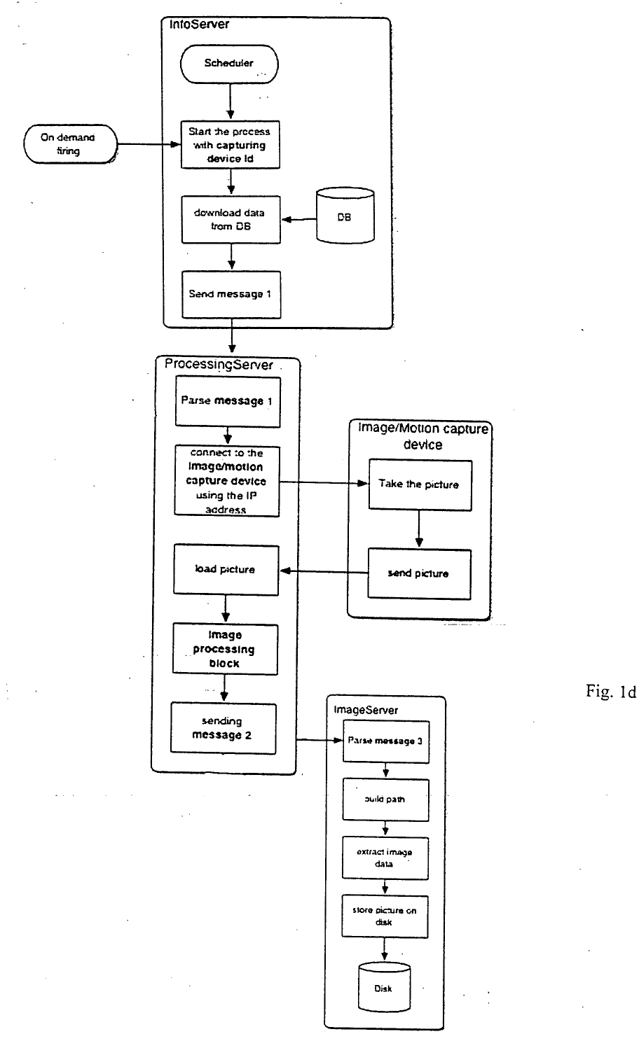

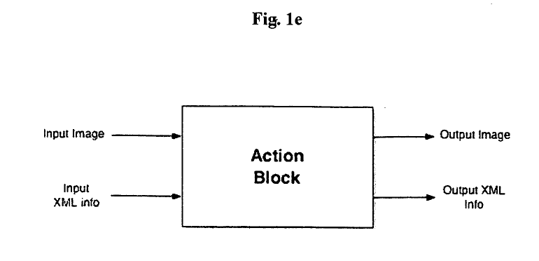

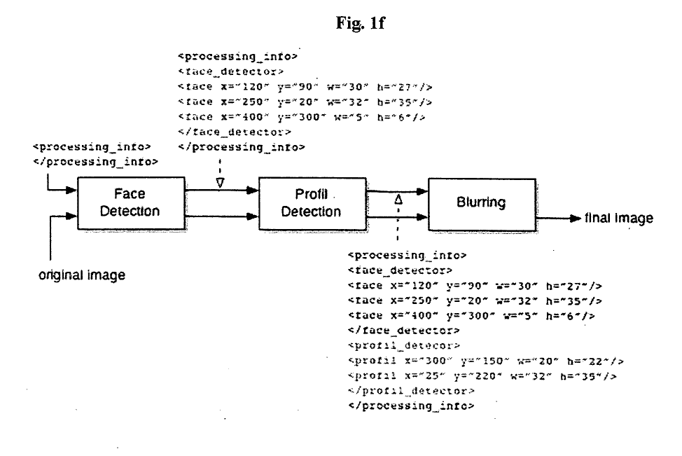

FIG. 1 is a block diagram of a location monitoring and image “broadcast” network 100 configured in accordance with one embodiment of the invention. The administrator system 101 and consumers 102 are in data communication with an internet 104 (e.g., the Internet). The administrator system 100 comprises a computer system running software thereon; however, this can be supplemented or even replaced with manual input from an administrating entity (such as a service provider). The consumers 102 are typically individual users on their own computer systems or client devices, which may be without limitation fixed, mobile, stand-alone, or integrated with other related or unrelated devices.

One or more information servers 106 are also in data communication with the internet 104, as well as one or more processing servers 108. The processing servers 108 are coupled to one or more video cameras 110. The video cameras 110 generate digitized video images that are provided to the processing servers 108 over an optionally secure pathway. As used herein, the term “secure” may include actual physical security for the link (such as where cabling is physically protected from surreptitious access), encryption or protection of the image or audio content, or encryption of protection of the authentication data (i.e., to mitigate spoofing or the like). All such network data and physical security measures (such as AES/DES, public/private key exchange encryption, etc.) are well known to those of ordinary skill in the art, and accordingly not described further herein.

Specifically, these cameras may comprise devices with an analog front end which generates an analog video signal which is then converted to the digital domain, or alternatively the cameras may generate digitized video data directly. The cameras may utilize, for example, CCD or CMOS based imagers, as well as motion detectors (IR or ultrasonic), and other types of sensors (including for example integrated microphones and acoustic signal processing).

In one exemplary embodiment of the invention, the cameras 110 are located in business premises (such as a restaurant, café, sporting venue, transportation station, etc.) or another public or private location. They preferably are in signal communication with a network server, and various attributes of the cameras can be controlled from the network (e.g., Internet) using a web (e.g., http) interface.

The processing servers 108 are triggered by the information server(s) (described below). The processing severs 108 perform the image processing tasks of the system, as well as receiving images from the cameras 110 according to an update delay.

Two primary processes are utilized in the configuration of FIG. 1: (i) an image “pull” loop; and (ii) a customer request handling process. The image pull process obtains images (and any associated data) from the premises of the subscribers via the interposed network; e.g., the Internet. These images are then processed and stored within a local database (not shown) of anonymous images. The request handling process receives end-user requests for images and/or data for one or more “monitored” subscriber locations, and identifies the correct image (and optionally related data) to send to the requesting user.

The image server(s) 107 comprise the interface between the consumer or end user and the images. It is preferably a web server of the type well known in the networking arts that stores the processed images (and optionally other information, such as metadata files associated with the images) obtained from the processing servers 108. These metadata files can be used for a variety of purposes, as described subsequently herein. The metadata can be provided by, e.g., the image originator or network operator (via the processing or image servers described herein), or a third-party “value added” entity.

Generally speaking, “metadata” comprises extra data not typically found in (or at least not visible to the users of) the baseline image or content. For each component of primary content (e.g., video/audio clip) or other content, one or more metadata files may be included that specify information related to that content. Various permutations and mechanisms for generating, adding and editing metadata will be recognized by those of ordinary skill, and hence are not described in greater detail herein.

The metadata information is packaged in a prescribed format such as XML, and associated with the primary content to be delivered to the end user; e.g., as responses to user selection of a video stream from a given location. Exemplary metadata comprises human-recognizable words and/or phrases that are descriptive of the content of the video stream in one or more aspects.

In one exemplary embodiment, another metadata file resides at the location (URL) of each requested content stream. All of the metadata files are rendered in the same format type (e.g., XML) for consistency, although heterogeneous file types may be used if desired. If metadata files are encrypted, then encryption algorithm information of the type well known in the art is included. The foregoing information may be in the form of self-contained data that is directly accessible from the file, or alternatively links or pointers to other sources where this information may be obtained.

In the exemplary embodiment of the invention, the consumers 102 will access the images of the aforementioned business or other public/private locations (as well as any associated metadata via web browsers (e.g., Mozilla Foxfire, Internet Explorer or Netscape Navigator). This provides an easy and pervasive mechanism to access and download images from the image server 107. In the illustrated embodiment, the consumer, or any web page referencing the image(s) of interest, will download the image using an http “GET” request or comparable mechanism. As an example, the following link will point to the image of interest with name picture_name, for the business with business identification number business_id:

imageserver.pagesjaunes.fr/<business_id>/<picture_name>.jpg

On the server side, the pictures are stored in such a folder tree. The web server is configured to append the image folder to its web tree.

The information server 106 typically performs the management and administration functions relating to the system, including inter alia storing information concerning each camera including the name/location of its installation (e.g., Joe's Cafe at 123 Main Street, or GPS Coordinates N.61° 11.0924′ W.130° 30.1660′, UTM coordinates 09V 0419200 6784100, etc.), as well as the updated user-, administrator- or service provider-specified delays for each camera. In the exemplary embodiment, the IP address of the image/motion capture device is also utilized, which will be given either by the ISP or the business/subscriber itself. This information can be stored in a local, remote or even distributed database as appropriate. The system administrator accesses the information server 106 to register the new information into the system. FIG. 1a illustrates this update process graphically, while FIG. 1b illustrates an exemplary format for a database record or entry for a monitored location.

Once the modifications are validated, the information server 106 updates a local event scheduler process so that it will initiate the processes for the new entries.

In the information server 106, there are two ways for the image acquiring process to be initiated. First, an on-demand trigger can be activated by the administrators or users. Alternatively (or concurrently), there is the aforementioned scheduler, that initiates requests at regular intervals for a given camera or sensor. The exemplary process is started with camera ID as an argument. The program then accesses the database to retrieve the information relative to the image/motion capture device (including, e.g., business ID, the server ID, the server address, the picture name, and IP address of the image/motion capture device). The information server 106 then connects to the given image server 107, and sends all the necessary information. An exemplary message format is as shown in FIG. 1c.

The administrator system 101 is used by the individuals controlling and configuring the system. For example, the administrator system 101 can be used to add new end-user or business user accounts (including new camera installations), specify update delays, and input other data relating to control and configuration aspects of the system.

During operation of the system 100, the video cameras 110 that are placed in the public or private venues relay image data back to the system, and hence ultimately to the consumers via the web interface. In a preferred embodiment of the business model of the invention, the commercial outlets pay or offer other consideration to have such a camera installed on their premises, along with being provided the associated services described herein. As will be described in greater detail subsequently herein, there are significant commercial and potentially other benefits to having a premises “wired” for such services.

The processing server 108 receives the video images from the cameras (whether directly or via one or more intermediary devices), and performs various types of processing on the images. Specifically, the processing server 108 receives the message described previously from the information server 106. From this message, it extracts the IP address of the image/motion capture device. Then it connects to the image/motion capture device. Using the web interface of the image/motion capture device, it downloads the image of the location of interest. The image is then sent to the image processing module. This module takes the raw image and turns it into the image that will be available as the output to the user(s). Finally, the processing server 108 uploads the picture on the image server 107.

The image server 107 receives messaging from the different processing servers 108, from which it extracts the picture_name and business_id. The server then extracts the image data from the (XML) message, and stores it into the image file.

FIG. 1d graphically illustrates the inter-relationship between the information, processing, and image servers of the exemplary system of FIG. 1.

It will be appreciated that the system of FIG. 1 may also be configured such that the subscribers (e.g., business owners or other entities from which the images are captured) may control either directly (themselves) or indirectly (via the network operator or other agent) one or more aspects of the image collection and/or analysis process. For example, a business may specify that they only want to broadcast images which contain a minimum number of people within the image or more (so as to avoid making the business look “dead”), or alternatively which contain less than or equal to a prescribed maximum. These controls can be implemented, for example, using well known software mechanisms (e.g., GUI menu selections or input fields) or other suitable approaches.

It will also be recognized that while shown as separate servers 106, 107, 108, the various functions performed by these entities can be integrated into a single device (or software process), or alternatively distributed in different ways. Hence, the configuration shown in FIG. 1 is merely exemplary in nature.

Image Processing—

The exemplary implementation of the image processing algorithm of the invention (e.g., that used in the image “pull” loop previously described) is designed as a “chain” of successive actions. Specifically, several actions are applied successively to the image data in order to obtain the desired results. FIG. 1e illustrates an exemplary processing block and associated interface structure. Each processing action “block” receives from the previous block an image and an XML data. The block reads the XML information and decides whether to use it or not. It then processes the image, performing detection, alteration or any other algorithm as described subsequently herein. When the image processing is done, the block generates an XML output that includes the relevant information from the XML input and the resultant processed image.

This architecture advantageously allows cascading of different algorithms. For example, an eye detection algorithm block can be followed by a lip detection algorithm. These stages or successive blocks can be either stand-alone or utilize information from the previous stage; e.g., the lip detection block can use the result from the eye detection algorithm to search the image more accurately.

FIG. 1f illustrates the foregoing “chain” image processing technique as applied to the face detection and obscuring algorithms of the present invention. The exemplary chain is initiated with an empty XML info and the original image. The first block 180 detects faces. It loads the image, run the detection algorithm and feeds the XML information with the detection result. The second block 182 receives the original unmodified image and the XML information from the previous block. It loads the image, runs the profile detection algorithm and adds the results to the XML information. Finally, the last block 184 receives the original image and the XML info from the previous block that includes information from all previous blocks. The blurring or obscuring block 184 will obscure every detected face and profile described in the XML information. It returns the final anonymized image.

In one embodiment, the aforementioned processing includes algorithmic analysis of the images to locate any artifacts of interest (e.g., human faces, hands, etc.) embedded therein. As described in greater detail elsewhere herein, privacy aspects relating to patrons of a given business or location dictate that their faces be obscured in any images streamed from that location. However, it may be desirable under certain circumstances to obscure other parts of the subject's anatomy, or other parts of the location where the image is drawn from. After being located within the image, these facial areas or other artifacts are obscured algorithmically. In the context of facial images, this obscuring can include: (i) reducing the resolution of the image in and around the facial areas, (ii) adding noise into the image in and around the facial areas, (iii) scrambling or permuting data in the facial regions, and/or (iv) overwriting the facial areas with another image or data. Additionally, the processing server 108 may also generate and add metadata to the image, including for example descriptive information relating to the image, timestamp, location identification information, information relating to the content of the image (e.g., dining area of Joe's Cafe), etc.

In some instances, the flow rate of images from the video cameras 110 will be sufficiently slow such that each image (frame) is processed effectively as a new image. In other instances, video streamed from the cameras will provide a more rapid sequence of images. In this latter case, the exemplary embodiment of the processing server 108 performs a face or artifact “tracking” algorithm in order to provide frame-to-frame correlation of the faces or other artifacts of interest.

In one embodiment, the face tracking algorithm involves reducing, for subsequent frames, the area over which a search for the face is performed. In particular, the search for the face is performed near the last known location of the same face in the prior frame, and only over a part of the entire image. This approach reduces the total processing power required to locate the face, and also makes acquisition quicker since less are must be searched and processed. This approach can be periodically or anecdotally interlaced with a “full” image search, such that any new faces or artifacts of interest which may be introduced into the frame can be located. For example, a waiter who periodically enters the image frame while serving diners at a restaurant could be detected in this fashion.

Furthermore, should the face(s) of interest become lost to the tracking algorithm, a complete search on the image is performed.

By providing a processing system that obscures artifacts such as facial images, the present embodiment of the invention advantageously allows for a “public” video camera to be used without unduly intruding on the privacy of those seated or present in the public spaces.

Furthermore, in some regions or countries, it is illegal to broadcast the image of a person without his consent. Issues relating to monetary compensation for use of a person's likeness (especially if they are famous) may also be involved. Thus, by providing a video system that obscures faces images, video of public places or other venues can be broadcast over the desired communication channels (e.g., the Internet) without violating the law of the relevant jurisdiction, or triggering compensation issues. This allows public places, including commercial sites such as restaurants or clubs, to display the current status of the premises to potential customers who wish to view the operations at a given point in time. For example, a customer wishing to dine at a particular restaurant may view video transmitted from that restaurant to see if people are waiting to be seated, or tables are available. It may also be used to determine other information about the exemplary restaurant venue, such as required dress code, spacing proximity of tables (i.e., is it a larger facility or more “cozy”), etc.

The image or “video” feed may also comprise multimedia, such as where audio from the location is streamed over the network to the prospective customers. For example, analog audio generated by the local microphone or transducer can be converted to a digital representation, and streamed along with the video according to a packetized protocol (such as the well known VoIP approach). This allows for a customer to get an idea of the ambient noise level in that location, the type of music being played (if any), and so forth. Audio “masking” or filtering can also be used to address audio-related privacy issues, akin to those for the video portion. For example, the audio sampling rate can be adjusted so as to make background or ambient conversations inaudible. Alternatively, short periodic “blanking” or scrambling intervals can be inserted, such that a user can hear the occasional word (or music), but only in short, choppy segments, thereby obscuring the conversations of patrons at that location. Furthermore, the pitch of the audio portion can be adjusted (e.g., by speeding up or slowing down the recording or playback rates) in order to frustrate recognition of a given individual's voice or patterns. Myriad other approaches to audio processing of the type well known in the art may be employed consistent with the invention.

Furthermore, other types of media may be employed, such as where audio is converted to textual content (such as via a speech recognition algorithm), or alternatively a text message is converted to a CELP or similar audio file for playback at the recipient's location. Various different forms of “media” are therefore contemplated by the invention.

Dedicated multimedia protocols may also be employed, such as those specified in ITU Standard H.323 (and H.225). These protocols provide for control, QoS, and signaling issues via, inter alia, use of the Real Time Protocol (RTP) and Real Time Control Protocol (RTCP), although it will be recognized that other protocols and approaches may be used. For example, a session between a computer present at the monitoring location (e.g., restaurant) and the user can be established using the Session Initiation Protocol (SIP), and this session used to support transport of various media types.

Regardless of the particular configuration employed, it will be appreciated that with either or both video and audio feeds, the user can readily perceive any number of different attributes relating to the camera/microphone location as if they were present in person.\

It will further be noted that the exemplary architecture of FIG. 1 is advantageously scalable in terms of all components, including cameras, image or processing servers, administrative servers, etc. This scalability allows for, inter alia, the addition of more processing power to the system by simply adding more processing servers to the system. Theoretically, even if the image processing is very computationally expensive, the system can handle as many businesses (image sources) and/or end users as desired.

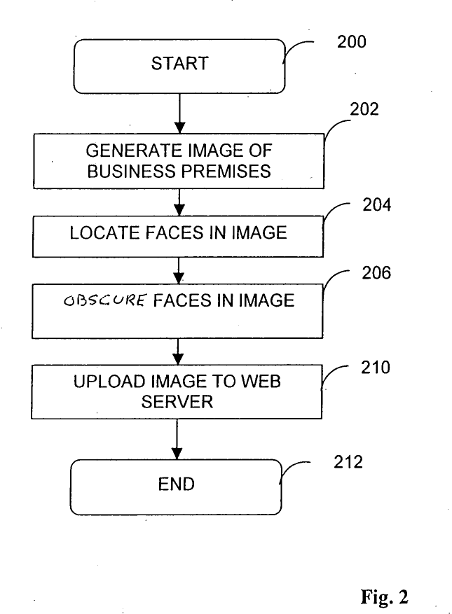

FIG. 2 is a flow chart illustrating a process performed in accordance with one embodiment of the invention that is consistent with the network shown in FIG. 1. The process begins at step 200 and at step 202 an image of a business premise or other public space is generated. At step 204 any faces in the image are located. The process of locating faces involved both searching for new faces and tracking old faces detected in any previous images.

At step 206 the faces in the image are obscured. Obscuring can including reducing the resolution of the image around the facial areas, adding noise into the image around the facial areas, or just overwriting facial areas with some other image or data. In one embodiment, so-called “down-sampling” of the type well known in the image processing arts is used. Blurring can be quite slow, when detection of large faces is enabled. Down-sampling (without blurring) leads to some degree of aliasing, but is very fast by comparison.

Once the faces or other artifacts have been obscured the modified image is uploaded to the web server at step 210. Customers and other people can then view the images to determine the status of the place of business or other public place. The process then terminates at step 212. In one embodiment of the invention the process is repeated for each new image received in the video stream.

By blocking the display of faces in images generated at public places the described embodiment of the invention allows for simple viewing of the condition of locations of interest while protecting the privacy of the people in those locations. This facilitates the ability of commercial locations to broadcast the conditions at their location for existing and potential customers to view while protecting the privacy of customers at their place of business. In some cases providing such privacy may be necessary to comply with local laws.

Video Conferencing—

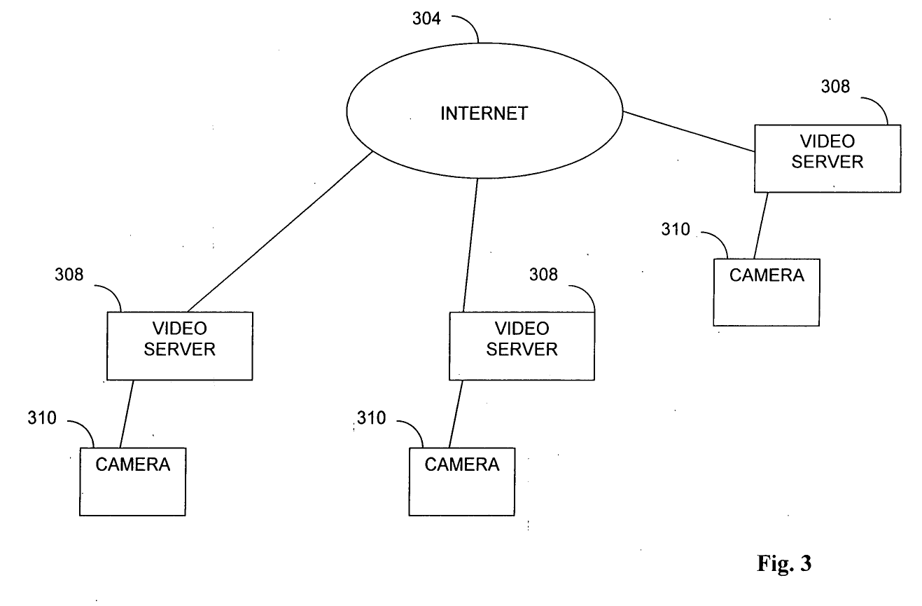

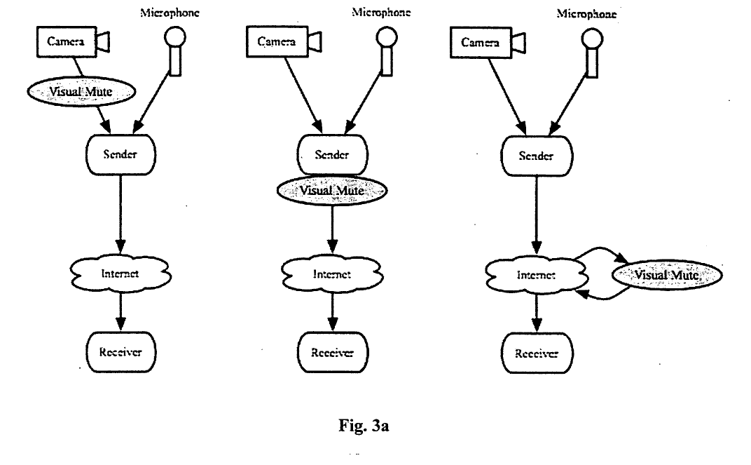

FIG. 3 is a block diagram of a video conferencing system configured in accordance with one embodiment of the invention. The video cameras 310 are coupled via wired or wireless data link to one or more video servers 308, which in turn are coupled to the bearer network (e.g., Internet) 304. Other types of networks may be used to transfer the video information from the server to the consumer(s) including for example standard telephone (circuit switched) networks, or satellite networks, HFC cable networks, millimeter wave systems, and so forth. In one variant, the Internet is used as the entire basis of the system; i.e., the camera data is formatted and streamed via on on-site DOCSIS cable modem, DSL connection, or T1 line to a web server, which acts as the aforementioned video server 308. This server, including the relayed or stored images, can then be accessed by one or more prospective customers via their Internet enabled devices. For example, a user's 3G smartphone with data capability could access a URL on the Internet and after proper authentication (if required), download images or video from the web server 308 relating to a given location.

The video servers 308 are typically computer systems including digital processing, mass storage, input/output signal interfaces, and other such components known to those of ordinary skill. However, it will be recognized that these servers may take on literally any form factor or configuration, in alternative embodiments of the invention. For example, the video server(s) 308 may comprise processing “blades” within a larger dedicated or non-dedicated equipment frame; e.g., one adapted to serve a large number of cameras from multiple locations. The servers may also comprise distributed processing systems, wherein two or more components of the “server” are disposed at disparate locations, yet maintained in direct or indirect data communication with one another, such as via a LAN, WAN, or other network arrangement.

During operation, the video cameras 310 generate digital video images that are received by the video server(s) 308. During normal video conference mode, these images are forwarded via the internet 304 to another video server 308 which displays the image to another member of the video conference. In additional to video, audio or other media information is generally transmitted as well via the same or comparable channels.

Also, while three video servers are shown in the embodiment of FIG. 2, video conferences involving more or less than three video servers may be performed consistent with the present invention. Multiple cameras/microphones may also be coupled to the same video servers 308, such as where a given location has multiple cameras for multiple views of personnel or premises. The video server 308 may also generate and add metadata to the image, including for example descriptive information relating to the image, timestamp, location identification information, information relating to the content of the image, etc.

As previously noted, dedicated multimedia protocols may also be employed in support of the video conference, such as those specified in ITU Standard H.323 (and H.225). These protocols provide for control, QoS, and signaling issues via, inter alia, use of the Real Time Protocol (RTP) and Real Time Control Protocol (RTCP), although it will be recognized that other protocols and approaches may be used. For example, a session between a computer present at the monitoring location (e.g., restaurant) and the user can be established using the Session Initiation Protocol (SIP), and this session used to support transport of various media types.

At some point in the video conference, one member of the conference may wish to talk “off line” (i.e., so that their voice and facial expressions/gestures are not perceivable to other members of the conference. During an audio conference, this would typically be accomplished by entering a “mute” mode where sound is no longer transmitted to the other party.

In accordance with one embodiment of the invention, the video conference may also be “muted” via entry into a similar mute mode. Entry into the mute mode may be accomplished by selection of a physical “mute” button or FFK/SFK, or software menu selection, voice command via speech recognition software, or some other input method well known in the art. Upon entering the mute mode, the video server 308 will obscure any faces in the video it transmits to the other member during the video conference. This will enable those members of the video conference to talk “off line” without the other party (or parties) being able to hear their voices or see their faces (including not being able to read their lips) while maintaining the underlying video link or session intact. This can be contrasted to prior art approaches wherein, to provide such video and audio “mute” features, the media stream for that user would have to be suspended or terminated, or the user would have to physically walk out of range or view of the video camera(s) and microphones, or otherwise disconnect these devices.

In one variant, the artifacts of interest (e.g., faces) are searched for and located when the conference enters the aforementioned mute mode. In another embodiment, the faces are searched for, located and tracked at all times during the conference, thereby allowing for lower latency in placing the muting into effect. This latter approach, however, generally consumes more local or server processing and storage resources, and hence may not be suited for all applications, especially those where the local “server” comprises a thin system such as a handheld mobile device or cellular phone.

The artifacts, once located, are then obscured by video server 308 in the mute mode. As previously noted, the term “obscure” herein includes any technique which achieves the aim of making the artifact visually imperceptible including, without limitation, reducing the resolution of the image around the facial area, adding noise into the image, or just overwriting this area with other image data or graphics. As described in greater detail subsequently herein, faces and other parts of the body are generally muted within the image region (e.g., rectangle) where they are detected. Places where motion occurs are muted by considering a small box around each pixel, and blurring all of the pixels in this box. Since the motion detection and face detection occur without input from each other, they may contain pixels that have been identified twice as “interesting” from a muting standpoint. In this case, the pixels belonging to faces are muted together as a block, and then the moving pixels are muted.

The video server 308 additionally can be configured to track the existing faces in the video image of interest, and search for new faces that enter the view of the video camera(s) from which it is receiving input. Once the mute mode is terminated, the artifact-obscuring process is similarly terminated, thereby allowing the conference to proceed as normal.

It will be appreciated that while the aforementioned obscuring function is performed on the video server 308 in the exemplary embodiment described herein, it may also be performed at other points or nodes in the network. For example, a central processing unit used by one or more of the video camera units 310 may also be used to perform the image processing. This “pre-processing” relieves the server 308 of much of the requisite processing burden, yet also requires the video cameras to be more capable. It will also be recognized, however, that varying degrees of distributed or shared processing can be employed, such as where each of the cameras (or other entities) performs some degree of data pre-processing, while the server(s) 308 perform the remainder.

FIG. 3a illustrates several alternative system configurations, including (i) a “closed box” system that connects to the camera output before it is attached to the conferencing system; (ii) as a software module to a conferencing software package; and (iii) as a service provided inside the bearer network itself.

As shown in FIG. 3a, the first alternative configuration (i) comprises an entity disposed within the signal/data path of the camera sensor(s) that provides the video processing features described elsewhere herein. This entity may take the form of, inter alia, a software process running on a processor indigenous to the camera(s), or alternatively a separate discrete hardware/firmware/software device in signal communication with the camera(s) and “sender” process (e.g., video conferencing application) shown in FIG. 3a. Accordingly, this embodiment will typically have the “video mute” process disposed locally with the camera, such as on the same premises, or one nearby.

The second alternative configuration (ii) of FIG. 3a shows the “video mute” entity disposed within or proximate to (in a logical sense) the sending entity, the latter which may or may not be physically proximate to the camera. For example, the sending entity may comprise a server disposed at a location populated by a number of different businesses, with the videoconferencing or camera feeds from each business being served by a centralized “sending entity” (e.g., server). Alternatively, the sending entity may comprise a server process disposed distant from the camera(s), such as across an enterprise LAN or WAN. The sending entity may also comprise a local video conferencing application, with the video mute process forming a module thereof.

The third alternative configuration (iii) of FIG. 3a shows the video mute process as part of (or in communication with) the bearer medium interposed between sender and receiver; e.g., the Internet, or alternatively a mobile communications network. For example, in one variant, the video mute process comprises a software process running on a server of a third party URL or website. In another variant, the process comprises a service provided by the network operator or service provider.

In certain environments, the video mute process may even be disposed on the receiver-side of the bearer network, such as where pre-processing of the image(s) is conducted before delivery over the local delivery network (e.g., LAN, WAN, or mobile communications network).

Myriad other configurations of the video mute process described above will be recognized by those of ordinary skill, given the present disclosure.

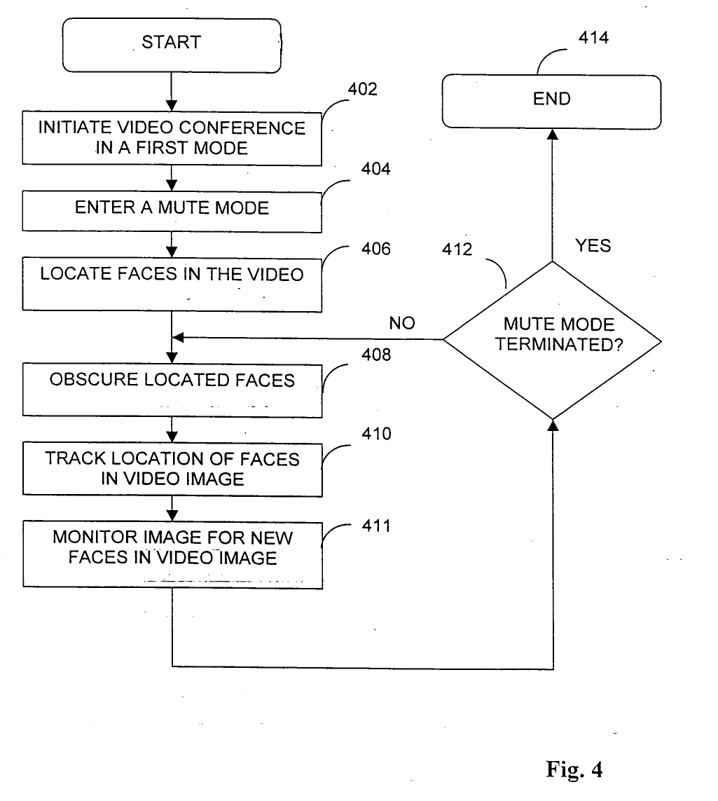

FIG. 4 is a flow chart further illustrating the operation of a video conferencing system such as the exemplary system shown in FIG. 3. The process begins at step 402 wherein a video conference is initiated in a first mode. This first mode is typically the normal mode in which video and audio information is exchanged between two or more members of the video conference, such as according to a prescribed protocol (e.g., H.323, SIP, etc.).

At step 404, the conference enters a second mode (i.e., the aforementioned “mute mode”). The mute mode is entered in response to some input from a user as previously described.

In response to entering mute mode, any faces in the video conference are located at step 406. This is typically done by searching through an entire image to find a set of features that match known face patterns. More detail on this aspect of the invention is provided subsequently herein.

Per step 408 of the process 300, any located faces are next obscured as previously described.

Per step 410, any faces identified in the image are tracked in subsequent images/frames. In one embodiment of the invention, this tracking is accomplished via a local search performed around the last area in which the face was detected, although other approaches can be employed. Other tracking procedures are described in greater detail subsequently herein.

At step 411, the video images are also monitored or analyzed for new faces that may be introduced. For example, additional people may enter the view of the camera to join the video conference. This monitoring of step 411 precludes the case where the tracking algorithm simply “locks on” to a static or even dynamic region of the prior image, and merely continues to monitor and track those already detected artifacts. If a periodic or anecdotal analysis for new artifacts were not conducted, any such new artifacts may not be detected at all (depending on their proximity relative to the already detected artifacts).

At step 412, it is determined if the mute mode has been terminated or is still required. If not, the process returns to step 408, and the located artifacts (e.g., faces) remain obscured. If the mute mode has been terminated, the process ends until again invoked.

It should be noted that the termination of the process shown in FIG. 4 does not mean that the video conference has ended, although the two events may be co-terminus. Normally, the video conference will continue with un-obscured images being transmitted until terminated by the user (or further “muting” employed). The video conference may also enter mute mode again. It should also be noted that, in accordance with one embodiment of the invention, during mute mode the audio portion of the conference is not transmitted.

It will also be appreciated by those of ordinary skill that the system may be configured to provide the ability of separate voice, hand/gesture, and video muting if desired. For example, a conventional audio mute button may be wholly appropriate for certain circumstances, whereas it may be desired on some occasions to only mute the video portion (e.g., to obscure facial expressions, and/or body parts, but not audio content). Hence, any number of different control combinations are envisaged by the present invention, to include without limitation: (i) separate audio and video muting; (ii) combined audio and video muting (i.e., both on or both off); or (iii) muting of either audio or video made permissive or predicated on the state of the muting of the other media (e.g., video muting only allowed when audio muting has already been invoked). Various combinations of motion-based hand and lip muting (described elsewhere herein) may also be utilized in order to provide the user(s) with a high degree of control over what information is communicated to the other participants.

As noted above, some embodiments of the invention include the use of artifact (e.g., face) discovery and face tracking functionality. In one variant, the face discovery and tracking is performed using the Viola and Jones (VJ) face detector algorithm implemented in software running on a microprocessor. The Viola and Jones face detector algorithm is also often referred to as a Haar face detector because it uses filters that approximate various moments of the image in accordance with Haar wavelet decomposition techniques. As is well known, Haar wavelets generally have the smallest number of coefficients, and therefore provide benefits in terms of processing overhead. In certain filtering applications, the length of the input signal needed to calculate one value of the filtered output is equivalent to the length of the filter. Therefore, the longer the filter, the longer the delay associated with the collection of the necessary input values.

The face detector of the exemplary embodiment of the invention further makes use of a cascade of “weak” classifiers. The face detector is typically trained using a form of boosting. As used in the present context, the term “boosting” refers generally to the combination or refinement of two or more weak classifiers into a single good or “strong” classifier by training over a plurality of artifacts (e.g., faces).

An exemplary VJ face detection algorithm useful with the present embodiment comprises that of Intel Corporation's OpenCV library. This library also includes a number of pre-trained classifier cascades, including three trained on frontal faces and one trained on profile faces. It will be recognized that these algorithms may be readily adapted to other types of artifacts as well, including for example human hands and bodies.

The structure and operation of VJ face detector algorithms are well known to those of ordinary skill in the signal and image processing arts, and accordingly are not described further herein. Other face recognition techniques may also be used, such as for example that described in U.S. Pat. No. 5,699,449 to Javidi issued on Dec. 16, 1997 previously discussed herein.

The exemplary implementations of the invention also use a software tool chain adapted to train new classifiers and to save them as data structures (e.g., computer files) in a desired format, such as the extensible markup language (XML), although it will be recognized that other structures and formats (e.g., HTML, SGML, etc.) may be used with success. These tools are also implemented in any number of different operating systems, including without limitation MS Windows™ and Linux, although others (such as TigerOS from Apple) may be used as well. The tool chain of the present invention is advantageously agnostic to the underlying file formats and operating system.

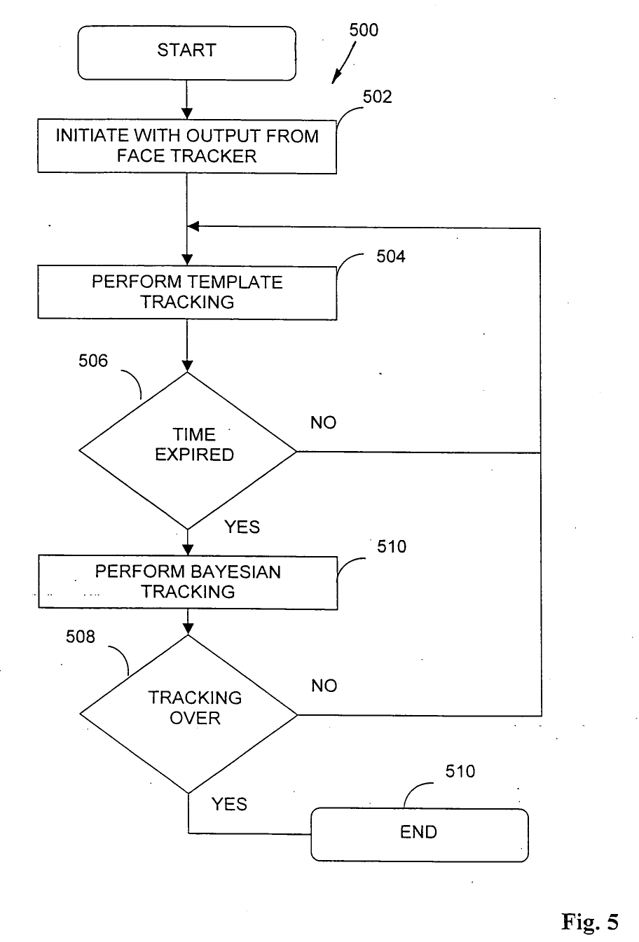

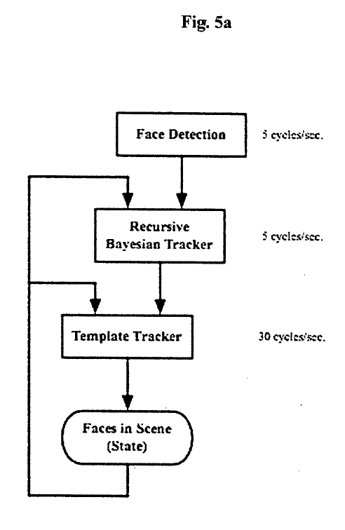

FIG. 5 is a flow chart illustrating the steps performed during tracking in accordance with one embodiment of the invention. This process may be used within any application of the present invention which requires tracking on an image-by-image or frame-by-frame basis, including without limitation the methodologies of FIGS. 2 and 4 previously described herein.

The exemplary process 500 of FIG. 5 begins at step 502 wherein the process is initiated with the initial output from application of a tracking algorithm to the initial image. In the exemplary embodiment, a Haar face tracking algorithm is employed, as supplemented by two trackers: one tracker using recursive Bayesian filtering and the other based on templates. It will be recognized, however, that other approaches (and even combinational or iterative approaches with multiple algorithms) may be used if desired. Furthermore, the methods described herein may be focused on other artifacts (e.g., hands, inanimate objects, etc.) along with or in place of the face tracking described.

At step 504, template face (or other artifact) tracking is performed, as described in greater detail subsequently herein.

At step 506, it is determined if a certain amount of time has expired. Alternatively, or concurrently, step 506 may determine if another criterion has been met, such as a sufficient number of template tracking steps or operations have been performed, a “termination” signal has been received, etc. If the requisite criteria have not been met, the process returns to step 504, and additional template tracking steps are performed. If the criteria have been met, then Bayesian tracking (described subsequently herein) is performed at step 510. It will be appreciated, however, that another form of tracking other than Bayesian may be substituted in the present method 500.

Once the Bayesian tracking has been performed at step 510, it is determined at step 508 if the tracking process has been completed. This determination may be based on any number of different criteria, such as expiration of a clock, count or timer, termination of the user session or conference, etc. The Bayesian and template tracking criteria may also be scaled or related to one another, such that a given number (m) of template tracking operations or steps are performed for every (n) Bayesian operations or steps. This allows the system designer (and even operator, via a gain or accuracy control parameter set via software or another mechanism) to control the tradeoff between template and Bayesian processing. Specifically, template tracking of the type utilized herein is generally less computationally intensive than Bayesian tracking. However, template tracking is also potentially subject to uncorrected errors. Template matching has been used in the illustrated embodiment as a method to reduce search time, and to handle temporary distortions not handled well by the Haar face detector. It has been noted by the Assignee hereof that if the template tracker was initialized once with the Haar detector, and then left to run, it was reasonably good at locking onto the face, as long as changes in appearance were not too rapid.

Thus, by performing an inner loop of template tracking as in the method 500 of FIG. 5, combined with an outer, less frequent, loop of Bayesian tracking, accuracy is maintained while computational processing is reduced over use of a purely Bayesian or similar technique.

If not completed, the process returns to step 504 where template tracking is again performed. Typically, the time or template tracking expiration count (as well as any other metrics associated with individual portions of the method 500) is also reset at this time. If tracking has been completed, the process terminates at step 510.

In accordance with one embodiment of the invention, the template-based tracker algorithm uses a region selected from a previous frame (the “template”) over which to perform artifact (e.g., face) searching. In the next (or another subsequent) image, the search is performed over an image patch having the largest normalized correlation coefficient. This coefficient is generally a measure of how well two images or segments or patches match, and accounts for lighting and contrast. It is calculated using the relationship of Eqn. (1) below, although it will be appreciated that other metrics may be used:

$${ρ}_{xy} = \frac{cov ( X , Y )}{{σ}_{X} {σ}_{Y}} = \frac{E ( ( X - {μ}_{X} ) ( Y - {μ}_{Y} ) )}{{σ}_{X} {σ}_{Y}} \qquad Eqn . ( 1 )$$

This approach reduces the total computational resources required, as running even a template search (let alone a Bayesian algorithm) across an entire image is comparatively slow. Thus, the template search is in effect pruned to focus on a relatively small window surrounding the original location of the template. It will be appreciated, however that the size or dimensions of the template region or window analyzed may be varied dynamically based on one or more parameters. For example, where the delay or inter-frame/image spacing is small, the expected motion of a face or other artifact may be small, and hence the area of analysis may be contracted. Alternatively, when the delay is large, the uncertainty in position is increased, and a larger search area may be warranted. The expected distance of movement may also be correlated to the search window.

Similarly, the type of artifact itself may be used as an input or determinant of the search region. For example, a face associated with a seated person may move relatively slowly over time as compared to a face of a standing or walking person, or a hand of a person, etc. Hence, multiple types or scales of analysis window are contemplated by the present invention, even within the same image (e.g., one for a seated “face”, a second for a walking face, and a third for a hand, etc.)

FIG. 5a is a graphical representation of one exemplary implementation of the methodology embodiment of the tracking methodology according to the present invention, including relative “cycle counts”.

The result of the foregoing approach is a tracker algorithm that is very fast for reasonably sized templates. In one embodiment of the invention, the tracking is further improved by searching a small number of scales or windows both smaller than and larger than the original artifact image. This approach assists in the tracking of faces or other artifacts moving toward or away from the camera, since their size changes as a function of distance from the camera. Similarly, aspect changes (e.g., some turning somewhat so as to expose more or less of the artifact of interest) can be handles more readily using such an approach.

In accordance with another embodiment of the invention, the recursive Bayesian tracker previously described uses (i) the previous state of the video stream (i.e., locations, sizes, etc. relating to identified artifacts), and (ii) a set of measurements about the current state of the artifacts, as inputs to the analysis algorithm. This set (ii) of measurements may include the relative location, size, aspect, etc. of any body parts or other artifacts of interest found in the image. This input analysis is followed by a data association process, wherein the measurements from the current state are paired with elements of the previous state. Ultimately, the state of the artifacts in the current frame or image is updated using the new measurements.

The aforementioned association process may also be governed by a matching evaluation process, such as e.g., a deterministic or even fuzzy decision model that rates the quality of match and assigns a score or “confidence” metric to the inter-frame match. This confidence metric may be used for other purposes, such as discarding frames where too low a confidence value is present, triggering secondary or confirmatory processing, extrapolation, etc.

In the exemplary embodiment, the state of the video stream comprises a list of artifacts (e.g., faces) and their associated positions, which are being tracked in the video stream. The measurements comprise a set of artifacts identified in the current frame of the video stream (and their associated data).

The data association process for the recursive tracking process proceeds in two steps: (i) determination of an “energy factor”, and (ii) producing an association or correspondence. First, a measure of an “energy factor” between each piece of the previous state is determined. The data for each measurement is obtained and stored in a matrix or other such data structure to facilitate analysis, although other approaches may be used. The energy factor comprises the normalized correlation coefficient between the two images, although other metrics may be substituted as the energy factor.

In the exemplary embodiment of the algorithm, a roughly one-to-one correspondence is derived, which attempts to maximize the total of the matching “energy” metric between pairs of previous state data and current frame/image measurements. The correspondence is referred to as being “roughly” one-to-one, since the sets of measurements and previous state may not be of the same size., so that some previous state information might not be associated with a new measurement, and conversely some new frame/image measurements might not be associated with any portion of the previous state. Once the correspondence has been derived, the state of the video stream is updated.

It will be recognized that when the aforementioned algorithm is configured such that no sophisticated probabilistic assumptions are made about the current or future state, the emphasis of the algorithm is more on the recursive aspects as opposed to the Bayesian aspects. However, the present invention can be configured to utilize such probabilistic assumptions or projections as part of its algorithm, thereby relying less on the recursive aspects. Certain types of applications may lend themselves to one approach more than another; hence, the present invention provides significant flexibility in this regard, since it is not necessarily tied to any particular analytic construct.

In accordance with one exemplary embodiment, an update process or stage is also utilized. This update stage considers a number of situations that arise when certain prescribed transients are introduced into the system. For example, in the context of a video conference or viewing of a business location, one or more persons may enter or leave a camera's field of view. In a “closed” system in which objects such as faces can neither leave nor enter the system, the update step would consist of two phases: 1) For each face with an associated measurement, incorporate the new measurement into the current state (such as by replacing the previous state with the measurement). 2) For each face without an associated measurement, use the “best guess” about what the present state of that face might be. This best guess can be obtained by, e.g., performing a template search in the image for each piece of state (face) that does not match some new measurement, or vice-versa.

While the present invention can readily be practiced using the aforementioned “closed” form, an alternative embodiment of the invention permits artifacts (e.g., faces) to be eliminated and added to the image. For example, if there is a face that does not correspond to a new (current frame) measurement, it must be decided whether to discount that face and remove it (as having left the image stream), or to update it with a best guess. In one variant of the invention, this decision is made by a persistence or other metric that is used to evaluate the discrepancy. For example, one such metric comprises monitoring of the number of frames the face in question has been tracked, and comparing this value with the number of frames it has been lost; when the ratio of these two numbers falls below a prescribed threshold, the face is dropped. Alternatively, a measurement of the consecutive number of frames where the face is lost may be used as a criterion for dropping the face; e.g., when the number of consecutive frames is greater than a prescribed value (indicating that its absence is persistent), the face is dropped. Myriad other approaches will be recognized by those of ordinary skill.

In the situation where a measurement of a new frame does not correspond to a previous piece of face state information, it must be decided whether or not to add the new measurement to the system as a new face. Non-corresponded measurements are generally assumed to represent new faces, although qualifying (e.g., persistence) criteria may be applied here as well.

In some instances, the image presented by a face or other artifact to the camera may be distorted. For example, a face may be wholly or partially shadowed or turned away from the camera for an extended period of time, during which only template tracking is used and errors accumulate. Once the face appears again at or near its previous position, illuminated or facing the camera again so that a new measurement is available to describe it, the measurement and the tracked face (complete with error accumulation from the template tracking process conducted in the interim) are sufficiently different that the system determines them to be two different faces. In one embodiment of the invention, this ambiguity is addressed by invoking an exception when a new measurement significantly overlaps an existing face (state). For example, when a “new” face covers more than some specified percentage of the area associated with a previously tracked face, the algorithm will correlate the new face to the old one, in effect merging them. In this case, the new measurement is discarded.

Once the aforementioned update process is completed, additional processing may be preformed to reduce false positive measurements, and mitigate other potential errors associated with the template tracking. In particular, after the update process, if there are two or more candidate faces that overlap by more than some percent of their area, the detected faces are combined.

Once a given artifact has been identified in the image, a priori assumptions may be used to estimate various attributes regarding the image. For example, with an identified face, the location of the eyes, mouth and body can be estimated; the algorithm can been trained on faces cropped between the forehead (bottom of the hairline) and the chin, and heuristics (or even deterministic relationships) developed. In the present context, given the area identified as a face by the algorithm, the eyes are estimated to be located in approximately the upper third of the face, while the mouth is located in the lowest third of the face. The body is approximately 3 heads wide, and 6 heads tall. Thus, if obscuring or anonymizing of bodies is performed, an area of this proportion, below the head, is blurred or otherwise altered as previously described.

Using the foregoing techniques, the algorithm may also be configured to selectively blank or obscure regions of the face itself, such as the eyes, mouth, etc. For example, using a priori assumptions regarding mouth placement relative to the face as a whole (e.g., a centroid representing the face), the algorithm can obscure that portion of the face region below center (it is known that the mouth will always be in the bottom portion of the face), and so many pixels high and wide, so as to obscure the mouth. This approach is independent of any motion detection of the mouth, which may also be used if desired.

As previously noted, other artifacts may also be detected and analyzed whether alone or in conjunction with the faces or bodies. For example, one embodiment of the invention utilizes hand detection and hand obscuring. In this case, motion may be used as a cue to determine what portions of the image should be muted, in accordance with the assumption that hands communicate information when they are moving. Simple frame-to-frame differencing is one mechanism that can be used to identify portions of the image where motion is occurring, although other more sophisticated approaches can be employed as well. The area around the pixels where movement occurs is then identified. This process can occur in parallel with the face tracking previously described if desired. In the exemplary embodiment the two methods do not feedback into each other; however, using the results of one or both such analyses as an input to the other is contemplated by the present disclosure. For example, validation of a new face (or elimination of an “old” or lost face) may be based at least in part on the presence (or absence) of any hand motion in a location associated with a given person, such as in the body region previously described. This approach is based on the a assumption that certain types of activity, or lack thereof, will always appear or be absent concurrently (i.e., hand gestures should only be present when there is a face, i.e., person, associated with them).

The use of motion detection in various embodiments of the invention is motivated by its generality and relative robustness. Using motion as a substitute for specifically identifying hands means that there is a smaller likelihood that communicative information conveyed by the hands will be seen when it is not intended to be seen. Furthermore, using motion will serve to mute the mouth of a person, when it is moving, even when the face detector fails. Hence, the motion detection is ideally used in a complementary fashion with the face detection previously described, although a purely motion based embodiment could be utilized where only hand and mouth movement need to be addressed. Under such a scenario, a “safety margin” could be imposed around the detected motion areas; for example, where motion is detected, it is presumed to be a hand or a mouth, and accordingly a region surrounding the are of detected motion could be obscured (so as to capture the face as well).

Lastly, in the case when a person enters the frame, it may take some time for the face detection and tracking to acquire the new person and include him/her as part of the state. The motion detection serves as a backup in this instance, muting the new person, even in the case of failure of the face tracking and detection.

It will also be recognized that while the present invention is described primarily in the context of discovery of a face or other artifact, methods and apparatus for identification of a face (i.e., correlation of the detected face to an identity) may be used with the invention as well. For example, the face detection, tracking and blanking algorithms described herein may also run in parallel with a facial identification program or algorithm. While this is seemingly counter-intuitive to the aim of privacy, there may be certain circumstances where its use is warranted, such as counter-terrorism operations, or in the context of video teleconferencing so as to identify conference participants (i.e., the expectation of privacy of the identity of conference participants usually does not exist, rather only the expectation of privacy as to the content of verbal, facial, or hand communications).

Integrated Circuit Device—

An exemplary integrated circuit useful for implementing the various image processing and tracking methodologies of the invention is described. In one embodiment, the integrated circuit comprises a System-on-Chip (SoC) device having a high level of integration, and includes a microprocessor-like CPU device (e.g., RISC, CISC, or alternatively a DSP core such as a VLIW or superscalar architecture) having, inter alia, a processor core, on-chip memory, DMA, and an external data interface.

It will be appreciated by one skilled in the art that the integrated circuit of the invention may contain any commonly available peripheral such as serial communications devices, parallel ports, timers, counters, high current drivers, analog to digital (A/D) converters, digital to analog converters (D/A), interrupt processors, LCD drivers, memories, wireless interfaces such as those complying with the Bluetooth, IEEE-802.11, UWB, PAN/802.15, WiMAX/802.16, or other such standards, and other related peripherals, as well as one or more associated microcontrollers. Further, the integrated circuit may also include custom or application specific circuitry that is specifically developed to support specific applications (e.g., rapid calculation of Haar wavelet filtering in support of the aforementioned tracking methodology of FIG. 5). This may include, e.g., design via a user-customizable approach wherein one or more extension instructions and/or hardware are added to the design before logic synthesis and fabrication.

Available data or signal interfaces include, without limitation, IEEE-1394 (Firewire), USB, UARTs, other serial or parallel interfaces

The processor and internal bus and memory architecture of the IC device is ideally adapted for high-speed data processing, at least sufficient to support the requisite image processing and tracking tasks necessary to implement the present invention effectively in real time. This may be accomplished, e.g., through a single high-speed multifunction digital processor, an array of smaller (e.g., RISC) cores, dedicated processors (such as a dedicated DSP, CPU, and interface controller), etc. Myriad different IC architectures known to those of ordinary skill will be recognized provided the present disclosure.

It is noted that power consumption of devices such as that described herein can be significantly reduced due in part to a lower gate count resulting from better block and signal integration. Furthermore, the above-described method provides the user with the option to optimize for low power. The system may also be run at a lower clock speed, thereby further reducing power consumption; the use of one or more custom instructions and/or interfaces allows performance targets to be met at lower clock speeds. Low power consumption may be a critical attribute for mobile image processing or tracking systems, such as those mounted on autonomous platforms, or embodied in hand-held or field-mobile devices.

Business Methods and Products—

Services that may be provided in various embodiments of the image “broadcast” invention may range widely, to include for example broadcasting or access for (i) a commercial site such as a restaurant, bar, or other such venue; (ii) a public or recreational site; (iii) use in law enforcement (e.g., blanking of informant's or agent's faces or other features to preserve their identity); (iv) use in reality television programs (e.g., “COPS”) where the identity of certain personnel must be kept anonymous; and (v) use in judicial proceedings (e.g., where live visual images are transmitted from a proceeding where the speaker's identity must be kept secret).

Under one business model, fee-based or incentive subscriptions to these services are offered to subscribers such as the aforementioned restaurant or other commercial venue. The services provider, such as a telecommunications company, network access provider, or even third party, could then install the equipment at the subscriber's premises, and then begin transmitting the anonymized images and/or other media. Potential customers of that restaurant can then view these images when considering whether to use that establishment. The service provider could even be compensated on a “hits” or “views” basis; the more views the restaurant gets, the higher the fee paid by subscriber (somewhat akin to click-throughs on Internet advertisements).

In another approach, a subscriber could have several cameras generating images of various locations in their premises. A “basic” subscription package might comprise just one primary camera location (e.g., the main dining room of a restaurant, a waiting room of a barbershop, or the dance floor in a nightclub), with no audio. With higher subscription rates or advanced packages, more viewed locations (and other media, such as audio) could be added. The image resolution and delays between updates could also be made dependent on the plan or package subscribed to, such as for example where a more comprehensive subscription package provides higher resolution video feed (versus a sequence of still images) and audio. Metadata might also comprise a subscription option. Such metadata might comprise, e.g., the song playlist for a nightclub, or the evening's menu for a restaurant, displayed in a separate viewing window or device (e.g., as part of a “ticker” or pop-up display on the user's display device).

The metadata may also comprise hyperlinks or other reference mechanisms which, if selected, allow the user to proceed to another URL that bears some logical relationship to the media feed they are viewing. For example, the metadata may comprise a set of URLs for other comparably located restaurants; the metadata is displayed to the user (e.g., via ticker, pop-up window, pull-down menu, etc.), at which point the user may select one or more of the URLs to access another location. Such might be the case where affiliated businesses refer overflow customers to their affiliates, or when one affiliate is closed and the other is not. This feature might comprise a portion of a premium service feature or package for the business owner subscriber and/or the end-user subscriber. The business owners benefit from not losing customers to other non-affiliated businesses, while the end-users benefit from having a ready source of alternates within geographic proximity of their first choice.

The metadata may also comprise search terms that can be used as input to a search engine. For example, the metadata may have an XML character string which, when entered into a search engine such as Google or Yahoo!, generates alternate hits having similar characteristics to those of the location being monitored (e.g., all restaurants within 5 mi. of the monitored location). This metadata can be automatically entered into the search engine using simple programming techniques, such as a graphic or iconic “shortcut” soft function key (SFK) or GUI region that the user simply selects to invoke the search. Alternatively, the metadata can be manually entered by the user via an input device (e.g., keypad, etc.), although this is more tedious.

It will also be recognized that the user-end of the aforementioned delivery system can be used as another basis for a business model, whether alone or in conjunction with that described above for the owner or the premises being monitored. For example, the network or internet service provider or other party (e.g., Telco or cable MSO) may operate a website where end-users can subscribe (or pay on a per use or comparable basis) to obtain access to video/audio feeds from pre-selected (or even dynamically or user-selected) locations. A user subscriber (as differentiated from a subscriber who owns the location being monitored) might, e.g., pay for X “views” per day, week or month, which would allow them a certain number of minutes per view, or a certain number of aggregated minutes (irrespective of where or when used), somewhat akin to “plan minutes” in the context of a cellular telephone subscription.

Great utility for the present invention can be found in the context of mobile devices such as PDAs, smartphones, laptops, etc., since many users will want to access the media feed(s) from a given location while in a mobile state, such as from their car, another business establishment, while walking downtown, etc. Hence, the media (especially video) feeds can be mirrored on multiple servers, e.g., one optimized for “thin” mobile devices having reduced data bandwidth and processing capability (and microbrowser), and a second optimized for high-speed connections and more capable devices (e.g., desktop PC). The user can merely enter the appropriate portal upon a prompt (e.g., are you mobile or fixed?), at which point their query will be routed to the URL or other access mechanism for that type of service.

It will also be noted that the methods and apparatus set forth in co-owned and co-pending U.S. patent application Ser. No. 11/______ filed Dec. 22, 2005 and entitled “METHODS AND APPARATUS FOR ORGANIZING AND PRESENTING CONTACT INFORMATION IN A MOBILE COMMUNICATION SYSTEM” and incorporated herein by reference in its entirety, may be used in conjunction with the present invention. Specifically, instead of a geographically or psychographically proximate set or cluster of contacts, a geographically or psychographically proximate cluster of viewable locations (or conference participants) may also be defined. For example, one exemplary software architecture according to the present invention comprises a module adapted to determine a location of a user (e.g., a GPS or other mechanism to locate their mobile unit), and determine based on this location a cluster of new (or pre-designated) viewable locations of a particular genre, such as for example all geographically proximate restaurants that are “viewable” via video/audio feed.

The user can also store or save such lists for different locations, or specify members of the pool of candidate entities from which to draw (and definition of “geographically proximate” or “psychographically proximate”), so that when they invoke this functionality (e.g., when walking down the street in a given part of the city), they will be presented with a list of proximate locations that are viewable, as drawn from their “favorites” list.

Also, the anonymized picture can be embedded as a reference in any other web page, such as an on-line business search engine, news page or journal, or the personal web page of the business from which the image was obtained. For example, a user looking for a business in the aforementioned on-line search page or journal might query or search for a restaurant in a given location. The website provides the answer as a web page/URL. The “live” picture may be added into this page. The designated picture will be downloaded each time the search or request is invoked, thereby, capturing the latest ambiance in the restaurant. All the other information comes from the database and webserver of the system (e.g., the search page or journal's host site). The only information needed is the matching between a business and the picture, thereby greatly simplifying the process of referencing the live image with the web page of the search page or journal.

As a communications product, the videoconferencing implementations of the invention may comprise either a service or hardware product offered to customers. As a service, the visually communicative information of the teleconference would be removed en route from the sender to the receiver (see discussion of FIG. 3a presented previously herein). The service provider would therefore merely act as an intermediary “value added” processor, and would have little capital burden (other than servers adapted to receive the data, process it, and send it out over established networks such as the Internet). As a hardware product, the invention can be realized as a discrete device (e.g., server or processing device) or integrated circuit which removes the communicative information. These discrete or integrated circuit devices can each also be built directly into the camera(s) if desired. Alternatively, these functions can comprise one or more software modules that are integrated with the videoconferencing software, thereby obviating complicated installations and separate servers. The video muting functionality described herein may accordingly be part of a subscriber “self install” kit, or as part of a larger videoconferencing product or application.

Thus, methods and apparatus for providing privacy in a video communication link have been described. Many other permutations of the foregoing system components and methods may also be used consistent with the present invention, as will be recognized by those of ordinary skill in the field.

It will also be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for generating a video transmission of a subject, the method comprising:
generating a first digital image of said subject;
processing said first digital image to locate at least one artifact in said digital image;
obscuring at least a portion of said at least one artifact in said first digital image, thereby producing an obscured digital image; and
transmitting said obscured image over a network.

2. The method as set forth in claim 1, further comprising:
receiving a second digital image of said subject;
tracking said at least one artifact in said second digital image based at least in part on the location of said at least one artifact in said first digital image; and
obscuring at least a portion of said at least one artifact in said second digital image.

3. The method as set forth in claim 1, wherein said obscuring comprises reducing the resolution of the image in a region occupied at least in part by said at least one artifact.

4. The method as set forth in claim 1, wherein said processing is performed using a Viola and Jones face detector algorithm.

5. The method as set forth in claim 2, wherein said act of tracking is performed according to the method comprising:
performing template tracking of said at least one artifact; and
performing Bayesian tracking of said at least one artifact.

6. The method as set forth in claim 5, wherein said template and Bayesian tracking are performed in a substantially iterative fashion, with said template tracking being performed more frequently than said Bayesian tracking.

7. The method as set forth in claim 2, further comprising:
detecting motion of at least one artifact between said first image and said second image; and
obscuring the areas in at least said second image where motion is detected.

8. Apparatus for performing video conferencing over a network comprising:
a video server in data communication with video camera apparatus adapted to create a stream of video images represented as digital data;
wherein said server is adapted to receive said digital data, said server further being configured to process said data to:
locate one or more artifacts in said images; and
obscure said artifacts in a mute mode of operation.

9. The apparatus as set forth in claim 8, wherein said video server is further adapted to transmit said stream of video images, including said images having said artifacts obscured, over a data network to at least one distant user as part of a video conferencing session.

10. The apparatus as set forth in claim 8, wherein said video server is further configured to track said artifacts between individual ones of said video images.

11. The apparatus as set forth in claim 10, wherein said tracking is performed by the method comprising:
performing template tracking of said one or more artifacts; and
performing Bayesian tracking on said one or more artifacts.

12. The apparatus as set forth in claim 9, where said video server is further adapted to:
detect motion between said first image and said second image; and
obscuring an area in at least said second image where motion is detected.

13. The apparatus as set forth in claim 11, wherein said video server comprises a video muting mode wherein said obscuring and said template and Bayesian tracking are performed, and said server enters said muting mode substantially in response to user input.

14. The apparatus as set forth in claim 13, wherein said one or more artifacts are located using a Haar wavelet-based face detector algorithm.

15. Apparatus for remotely displaying a sequence of video images from a public place, said video images generated by at least one a video camera disposed said public place, the apparatus comprising:
a processing server comprising:
an interface adapted to receiving said sequence of video images from said at least one camera;
a processor; and
a computer program running on said processor, said computer program comprising at least one module adapted to locate at least one face within at least individual ones of said video images, said at least one module further being adapted to selectively obscure at least portions of said at least one faces.

16. The apparatus as set forth in claim 15, wherein said apparatus further comprises a network interface in signal communication with said server and configured for transmitting said video images over a network to a logically remote node.

17. The apparatus as set forth in claim 15, wherein said processing server is further configured to tracking said face is said stream of video images, said tracking comprising:
performing template tracking of said at least one face; and
performing recursive Bayesian tracking on said at least one face.

18. The apparatus as set forth in claim 15, where said server is further adapted to, using said computer program:
detect motion occurring between at least one artifact in said first image and said second image; and
obscure an area in at least one of said first or second images when motion is detected.

19. The apparatus as set forth in claim 16, wherein said server comprises a video muting mode wherein said selective obscuring and said template and Bayesian tracking are performed, and said server enters said muting mode automatically.

20. The apparatus as set forth in claim 15, wherein said at least one face is identified using a Viola and Jones face detection algorithm.

21. A method of recursive image tracking, comprising:
providing a tracking algorithm having first and second tracking routines;
performing said first tracking routine at least once with respect to at least one image frame;
evaluating whether at least one first criterion has been met;
if said at least one first criterion has been met, then performing said second routine at least once;
after completion of said at least one performance of said second routine, evaluating at least one second criterion; and
if said at least one second criterion has been met, terminating said method for at least a period of time.

22. The method of claim 21, wherein said first routine comprises an inner loop comprising a first tracking approach, and said second routine comprises an outer loop comprising a second tracking approach, said outer loop being performed less frequently than said inner loop.

23. The method of claim 22, wherein said first tracking approach comprises a template-based routine, and said second tracking approach comprises a Bayesian routine.

24. The method of claim 21, wherein said first routine uses a region selected from an image frame previous to said at least one image frame, over which to perform artifact searching.

25. The method of claim 24, wherein artifact searching is performed over an image region having the largest normalized correlation coefficient (NCC) in at least one subsequent image frame.
